(19) United States
(12) Patent Application Publication
(10) Pub. No.: US 2022/0315207 A1
(43) Pub. Date: Oct. 6, 2022

(54) AIRCRAFT FOR NEUTRALIZING VERTICAL FLIGHT

(71) Applicant: BETA AIR, LLC, South Burlington, VT (US)

(72) Inventors: Alexander Hoekje List, South Burlington, VT (US); David L. Churchill, Winooski, NY (US)

(73) Assignee: BETA AIR, LLC, SOUTH BURLINGTON, VT (US)

(21) Appl. No.: 17/349,269

(22) Filed: Jun. 16, 2021

Related U.S. Application Data
(63) Continuation-in-part of application No. 17/222,539, filed on Apr. 5, 2021.

(51) Int. Cl. B64C 15/02; B64C 29/00; B64D 27/24

(52) U.S. Cl. CPC B64C 15/02; B64C 29/0033; B64D 27/24; B64D 2045/0085

(57) ABSTRACT

An aircraft for neutralizing flight comprising a fuselage, at least a power source, a plurality of laterally extending elements attached to the fuselage, a plurality of downward directed propulsors attached to the plurality of laterally extending elements and electrically connected to at least a power source, wherein the plurality of downward directed propulsors have a rotational axis offset from a vertical axis by a yaw-torque-cancellation angle, and a flight controller configured to include a notification unit.

### CROSS-REFERENCE TO RELATED APPLICATIONS

This application is a continuation-in-part of U.S. patent application Ser. No. 17/222,539, filed on Apr. 5, 2021, and titled, “AIRCRAFT FOR SELF-NEUTRALIZING FLIGHT,” which is incorporated by reference herein in its entirety.

### FIELD OF THE INVENTION

The present invention generally relates to the field of electrically propelled vehicles. In particular, the present invention is directed to an aircraft for neutralizing flight.

### BACKGROUND

In electrically propelled vehicles, such as an electric vertical takeoff and landing (eVTOL) aircraft, it is essential to maintain the integrity of the aircraft until safe landing. In some flights, a component of the aircraft may experience a malfunction or failure which will put the aircraft in an unsafe mode which will compromise the safety of the aircraft, passengers and onboard cargo.

### SUMMARY OF THE DISCLOSURE

In an aspect an aircraft for neutralizing flight includes a fuselage, at least a power source, a plurality of laterally extending elements attached to the fuselage, a plurality of downward directed propulsors attached to the plurality of laterally extending elements and electrically connected to the at least a power source, wherein the plurality of downward directed propulsors have a rotational axis offset from a vertical axis by a yaw-torque-cancellation angle, and a flight controller configured to include a notification unit.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a diagrammatic representation of an exemplary embodiment of an electric aircraft;

FIG. 2 is a diagrammatic representation of an exemplary embodiment of a yaw-torque-cancellation angle;

FIG. 3 is a diagrammatic representation of an exemplary embodiment of self-neutralizing flight;

FIG. 4 a block diagram illustrating an exemplary embodiment of an aircraft for self-neutralizing flight;

FIG. 5 is a flow diagram illustrating an exemplary embodiment for a method of an aircraft for self-neutralizing flight;

FIG. 6 is a block diagram illustrating an aircraft for neutralizing flight;

FIG. 7 is a block diagram illustrating an exemplary embodiment of a flight controller;

FIG. 8 is a block diagram illustrating an exemplary embodiment of a machine-learning module;

FIG. 9 is a flow diagram illustrating a method for neutralizing flight;

FIG. 10 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

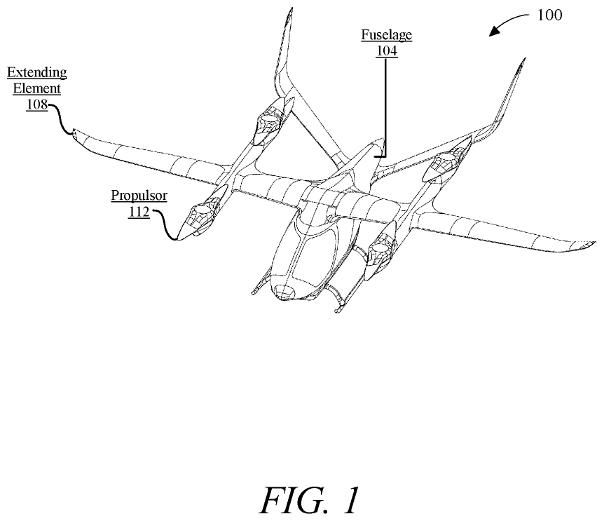

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At a high level, aspects of the present disclosure are directed to an aircraft for neutralizing flight. In an embodiment, this disclosure detects a failure event of a flight component in an aircraft. Aspects of the present disclosure can be used to determine a corrective action for the flight components of the plurality of flight components to generate a corrective action. Aspects of the present disclosure allow for transmitting a notification to a pilot and performing a corrective action as a function of a pilot signal. Exemplary embodiments illustrating aspects of the present disclosure are described below in the context of several specific examples.

Referring now to FIG. 1, an exemplary embodiment of an aircraft 100 for self-neutralizing flight is illustrated. System 100 may include an electrically powered aircraft. In embodiments, electrically powered aircraft may be an electric vertical takeoff and landing (eVTOL) aircraft. Electric aircraft may be capable of rotor-based cruising flight, rotor-based takeoff, rotor-based landing, fixed-wing cruising flight, airplane-style takeoff, airplane-style landing, and/or any combination thereof. Rotor-based flight, as described herein, is where the aircraft generated lift and propulsion by way of one or more powered rotors coupled with an engine, such as a “quad copter,” multi-rotor helicopter, or other vehicle that maintains its lift primarily using downward thrusting propulsors. Fixed-wing flight, as described herein, is where the aircraft is capable of flight using wings and/or foils that generate life caused by the aircraft's forward airspeed and the shape of the wings and/or foils, such as airplane-style flight.

Continuing to refer to FIG. 1, an illustration of forces is illustrated in an electric aircraft. During flight, a number of forces may act upon the electric aircraft. Forces acting on an aircraft during flight may include thrust, the forward force produced by the rotating element of the aircraft and acts parallel to the longitudinal axis. Drag may be defined as a rearward retarding force which is caused by disruption of airflow by any protruding surface of the aircraft such as, without limitation, the wing, rotor, and fuselage. Drag may oppose thrust and acts rearward parallel to the relative wind. Another force acting on aircraft may include weight, which may include a combined load of the aircraft itself, crew, baggage and fuel. Weight may pull aircraft downward due to the force of gravity. An additional force acting on aircraft may include lift, which may act to oppose the downward force of weight and may be produced by the dynamic effect of air acting on the airfoil and/or downward thrust from at least a propulsor. Lift generated by the airfoil may depends on speed of airflow, density of air, total area of an airfoil and/or segment thereof, and/or an angle of attack between air and the airfoil.

Still referring to FIG. 1, aircraft 100 includes a fuselage 104. As used in this disclosure a “fuselage” is the main body of an aircraft, or in other words, the entirety of the aircraft except for the cockpit, nose, wings, empennage, nacelles, any and all control surfaces, and generally contains an aircraft's payload. Fuselage 104 may comprise structural elements that physically support the shape and structure of an aircraft. Structural elements may take a plurality of forms, alone or in combination with other types. Structural elements may vary depending on the construction type of aircraft and specifically, the fuselage. Fuselage 104 may comprise a truss structure. A truss structure is often used with a lightweight aircraft and comprises welded steel tube trusses. A truss, as used herein, is an assembly of beams that create a rigid structure, often in combinations of triangles to create three-dimensional shapes. A truss structure may alternatively comprise wood construction in place of steel tubes, or a combination thereof. In embodiments, structural elements may comprise steel tubes and/or wood beams. In an embodiment, and without limitation, structural elements may include an aircraft skin. Aircraft skin may be layered over the body shape constructed by trusses. Aircraft skin may comprise a plurality of materials such as plywood sheets, aluminum, fiberglass, and/or carbon fiber, the latter of which will be addressed in greater detail later in this paper.

In embodiments, aircraft fuselage 104 may comprise geodesic construction. Geodesic structural elements may include stringers wound about formers (which may be alternatively called station frames) in opposing spiral directions. A stringer, as used herein, is a general structural element that comprises a long, thin, and rigid strip of metal or wood that is mechanically coupled to and spans the distance from, station frame to station frame to create an internal skeleton on which to mechanically couple aircraft skin. A former (or station frame) can include a rigid structural element that is disposed along the length of the interior of aircraft fuselage 104 orthogonal to the longitudinal (nose to tail) axis of the aircraft and forms the general shape of fuselage 104. A former may comprise differing cross-sectional shapes at differing locations along fuselage 104, as the former is the structural element that informs the overall shape of a fuselage 104 curvature. In embodiments, aircraft skin can be anchored to formers and strings such that the outer mold line of the volume encapsulated by the formers and stringers comprises the same shape as aircraft 100 when installed. In other words, former(s) may form a fuselage's ribs, and the stringers may form the interstitials between such ribs. The spiral orientation of stringers about formers provides uniform robustness at any point on an aircraft fuselage such that if a portion sustains damage, another portion may remain largely unaffected. Aircraft skin would be mechanically coupled to underlying stringers and formers and may interact with a fluid, such as air, to generate lift and perform maneuvers.

In an embodiment, and still referring to FIG. 1, fuselage 104 may comprise monocoque construction. Monocoque construction may include a primary structure that forms a shell (or skin in an aircraft's case) and supports physical loads. Monocoque fuselages are fuselages in which the aircraft skin or shell is also the primary structure. In monocoque construction aircraft skin would support tensile and compressive loads within itself and true monocoque aircraft can be further characterized by the absence of internal structural elements. Aircraft skin in this construction method is rigid and can sustain its shape with no structural assistance form underlying skeleton-like elements. Monocoque fuselage may comprise aircraft skin made from plywood layered in varying grain directions, epoxy-impregnated fiberglass, carbon fiber, or any combination thereof.

According to embodiments, fuselage 104 can include a semi-monocoque construction. Semi-monocoque construction, as used herein, is a partial monocoque construction, wherein a monocoque construction is describe above detail. In semi-monocoque construction, aircraft fuselage 104 may derive some structural support from stressed aircraft skin and some structural support from underlying frame structure made of structural elements. Formers or station frames can be seen running transverse to the long axis of fuselage 104 with circular cutouts which are generally used in real-world manufacturing for weight savings and for the routing of electrical harnesses and other modern on-board systems. In a semi-monocoque construction, stringers are the thin, long strips of material that run parallel to fuselage's long axis. Stringers may be mechanically coupled to formers permanently, such as with rivets. Aircraft skin may be mechanically coupled to stringers and formers permanently, such as by rivets as well. A person of ordinary skill in the art will appreciate that there are numerous methods for mechanical fastening of the aforementioned components like crews, nails, dowels, pins, anchors, adhesives like glue or epoxy, or bolts and nuts, to name a few. A subset of fuselage under the umbrella of semi-monocoque construction is unibody vehicles. Unibody, which is short for “unitized body” or alternatively “unitary construction”, vehicles are characterized by a construction in which the body, floor plan, and chassis form a single structure. In the aircraft world, unibody would comprise the internal structural elements like formers and stringers are constructed in one piece, integral to the aircraft skin as well as any floor construction like a deck.

Still referring to FIG. 1, stringers and formers which account for the bulk of any aircraft structure excluding monocoque construction can be arranged in a plurality of orientations depending on aircraft operation and materials. Stringers may be arranged to carry axial (tensile or compressive), shear, bending or torsion forces throughout their overall structure. Due to their coupling to aircraft skin, aerodynamic forces exerted on aircraft skin will be transferred to stringers. The location of said stringers greatly informs the type of forces and loads applied to each and every stringer, all of which may be handled by material selection, cross-sectional area, and mechanical coupling methods of each member. The same assessment may be made for formers. In general, formers are significantly larger in cross-sectional area and thickness, depending on location, than stringers. Both stringers and formers may comprise aluminum, aluminum alloys, graphite epoxy composite, steel alloys, titanium, or an undisclosed material alone or in combination.

In an embodiment, and still referring to FIG. 1, stressed skin, when used in semi-monocoque construction is the concept where the skin of an aircraft bears partial, yet significant, load in the overall structural hierarchy. In other words, the internal structure, whether it be a frame of welded tubes, formers and stringers, or some combination, is not sufficiently strong enough by design to bear all loads. The concept of stressed skin is applied in monocoque and semi-monocoque construction methods of fuselage 104. Monocoque comprises only structural skin, and in that sense, aircraft skin undergoes stress by applied aerodynamic fluids imparted by the fluid. Stress as used in continuum mechanics can be described in pound-force per square inch (lbf/in²) or Pascals (Pa). In semi-monocoque construction stressed skin bears part of the aerodynamic loads and additionally imparts force on the underlying structure of stringers and formers.

Still referring to FIG. 1, it should be noted that an illustrative embodiment is presented only, and this disclosure in no way limits the form or construction method of a system and method for loading payload into an eVTOL aircraft. In embodiments, fuselage 104 may be configurable based on the needs of the eVTOL per specific mission or objective. The general arrangement of components, structural elements, and hardware associated with storing and/or moving a payload may be added or removed from fuselage 104 as needed, whether it is stowed manually, automatedly, or removed by personnel altogether. Fuselage 104 may be configurable for a plurality of storage options. Bulkheads and dividers may be installed and uninstalled as needed, as well as longitudinal dividers where necessary. Bulkheads and dividers may be installed using integrated slots and hooks, tabs, boss and channel, or hardware like bolts, nuts, screws, nails, clips, pins, and/or dowels, to name a few. Fuselage 104 may also be configurable to accept certain specific cargo containers, or a receptable that can, in turn, accept certain cargo containers.

Still referring to FIG. 1, aircraft 100 includes at least a power source located within fuselage 104. As used in this disclosure a “power source” is a source that may propel a rotor, or set of airfoils, through a fluid medium, like air, generating life. Power source may include a motor A motor may include without limitation, any electric motor, where an electric motor is a device that converts electrical energy into mechanical energy, for instance by causing a shaft to rotate. A motor may be driven by direct current (DC) electric power; for instance, a motor may include a brushed DC motor or the like. A motor may be driven by electric power having varying or reversing voltage levels, such as alternating current (AC) power as produced by an alternating current generator and/or inverter, or otherwise varying power. A motor may include, without limitation, a brushless DC electric motor, a permanent magnet synchronous motor, a switched reluctance motor, and/or an induction motor; persons skilled in the art, upon reviewing the entirety of this disclosure, will be aware of various alternative or additional forms and/or configurations that a motor may take or exemplify as consistent with this disclosure. In addition to inverter and/or switching power source, a circuit driving motor may include electronic speed controllers (not shown) or other components for regulating motor speed, rotation direction, torque, and/or dynamic braking.

In an embodiment, and still referring to FIG. 1, power source may include an energy source. As used in this disclosure an “energy source” is a device that is capable of providing energy to the plurality of power sources. An energy source may include, for example, a generator, a photovoltaic device, a fuel cell such as a hydrogen fuel cell, direct methanol fuel cell, and/or solid oxide fuel cell, an electric energy storage device (e.g. a capacitor, an inductor, and/or a battery). An energy source may also include a battery cell, or a plurality of battery cells connected in series into a module and each module connected in series or in parallel with other modules. Configuration of an energy source containing connected modules may be designed to meet an energy or power requirement and may be designed to fit within a designated footprint in an electric aircraft in which aircraft 100 may be incorporated.

In an embodiment, and still referring to FIG. 1, an energy source may be used to provide a steady supply of electrical power to a load over the course of a flight by a vehicle or other electric aircraft. For example, the energy source may be capable of providing sufficient power for “cruising” and other relatively low-energy phases of flight. An energy source may also be capable of providing electrical power for some higher-power phases of flight as well, particularly when the energy source is at a high SOC, as may be the case for instance during takeoff. In an embodiment, the energy source may be capable of providing sufficient electrical power for auxiliary loads including without limitation, lighting, navigation, communications, de-icing, steering or other systems requiring power or energy. Further, the energy source may be capable of providing sufficient power for controlled descent and landing protocols, including, without limitation, hovering descent or runway landing. As used herein the energy source may have high power density where the electrical power an energy source can usefully produce per unit of volume and/or mass is relatively high. The electrical power is defined as the rate of electrical energy per unit time. An energy source may include a device for which power that may be produced per unit of volume and/or mass has been optimized, at the expense of the maximal total specific energy density or power capacity, during design. Non-limiting examples of items that may be used as at least an energy source may include batteries used for starting applications including Li ion batteries which may include NCA, NMC, Lithium iron phosphate (LiFePO4) and Lithium Manganese Oxide (LMO) batteries, which may be mixed with another cathode chemistry to provide more specific power if the application requires Li metal batteries, which have a lithium metal anode that provides high power on demand, Li ion batteries that have a silicon or titanite anode, energy source may be used, in an embodiment, to provide electrical power to an electric aircraft or drone, such as an electric aircraft vehicle, during moments requiring high rates of power output, including without limitation takeoff, landing, thermal de-icing and situations requiring greater power output for reasons of stability, such as high turbulence situations, as described in further detail below. A battery may include, without limitation a battery using nickel based chemistries such as nickel cadmium or nickel metal hydride, a battery using lithium ion battery chemistries such as a nickel cobalt aluminum (NCA), nickel manganese cobalt (NMC), lithium iron phosphate (LiFePO4), lithium cobalt oxide (LCO), and/or lithium manganese oxide (LMO), a battery using lithium polymer technology, lead-based batteries such as without limitation lead acid batteries, metal-air batteries, or any other suitable battery. Persons skilled in the art, upon reviewing the entirety of this disclosure, will be aware of various devices of components that may be used as an energy source.

Still referring to FIG. 1, an energy source may include a plurality of energy sources, referred to herein as a module of energy sources. The module may include batteries connected in parallel or in series or a plurality of modules connected either in series or in parallel designed to deliver both the power and energy requirements of the application. Connecting batteries in series may increase the voltage of at least an energy source which may provide more power on demand. High voltage batteries may require cell matching when high peak load is needed. As more cells are connected in strings, there may exist the possibility of one cell failing which may increase resistance in the module and reduce the overall power output as the voltage of the module may decrease as a result of that failing cell. Connecting batteries in parallel may increase total current capacity by decreasing total resistance, and it also may increase overall amp-hour capacity. The overall energy and power outputs of at least an energy source may be based on the individual battery cell performance or an extrapolation based on the measurement of at least an electrical parameter. In an embodiment where the energy source includes a plurality of battery cells, the overall power output capacity may be dependent on the electrical parameters of each individual cell. If one cell experiences high self-discharge during demand, power drawn from at least an energy source may be decreased to avoid damage to the weakest cell. The energy source may further include, without limitation, wiring, conduit, housing, cooling system and battery management system. Persons skilled in the art will be aware, after reviewing the entirety of this disclosure, of many different components of an energy source.

Still referring to FIG. 1, aircraft 100 includes a plurality of laterally extending elements 108 attached to fuselage 104. As used in this disclosure a “laterally extending element” is an element that projects essentially horizontally from fuselage, including an outrigger, a spar, and/or a fixed wing that extends from fuselage. Wings may be structures which include airfoils configured to create a pressure differential resulting in lift. Wings may generally dispose on the left and right sides of the aircraft symmetrically, at a point between nose and empennage. Wings may comprise a plurality of geometries in planform view, swept swing, tapered, variable wing, triangular, oblong, elliptical, square, among others. A wing's cross section may geometry comprises an airfoil. An “airfoil” as used in this disclosure is a shape specifically designed such that a fluid flowing above and below it exert differing levels of pressure against the top and bottom surface. In embodiments, the bottom surface of an aircraft can be configured to generate a greater pressure than does the top, resulting in lift. Laterally extending element 108 may comprise differing and/or similar cross-sectional geometries over its cord length or the length from wing tip to where wing meets the aircraft's body. One or more wings may be symmetrical about the aircraft's longitudinal plane, which comprises the longitudinal or roll axis reaching down the center of the aircraft through the nose and empennage, and the plane's yaw axis. Laterally extending element may comprise controls surfaces configured to be commanded by a pilot or pilots to change a wing's geometry and therefore its interaction with a fluid medium, like air. Control surfaces may comprise flaps, ailerons, tabs, spoilers, and slats, among others. The control surfaces may dispose on the wings in a plurality of locations and arrangements and in embodiments may be disposed at the leading and trailing edges of the wings, and may be configured to deflect up, down, forward, aft, or a combination thereof. An aircraft, including a dual-mode aircraft may comprise a combination of control surfaces to perform maneuvers while flying or on ground.

Still referring to FIG. 1, aircraft 100 includes a plurality of downward directed propulsors 112 attached to the plurality of extending elements 108 and electrically connected to the at least power source. As used in this disclosure a “propulsor” is a component and/or device used to propel a craft by exerting force on a fluid medium, which may include a gaseous medium such as air or a liquid medium such as water. In an embodiment, when a propulsor twists and pulls air behind it, it will, at the same time, push an aircraft forward with an equal amount of force. The more air pulled behind an aircraft, the greater the force with which the aircraft is pushed forward. Propulsor may include any device or component that consumes electrical power on demand to propel an electric aircraft in a direction or other vehicle while on ground or in-flight. As used in this disclosure, “attached” means that at least a portion of a device, component, or circuit is connected to at least a portion of the aircraft via a mechanical coupling and/or attachment and/or fastening component and/or mechanism. Said mechanical coupling can include, for example, rigid coupling, such as beam coupling, bellows coupling, bushed pin coupling, constant velocity, split-muff coupling, diaphragm coupling, disc coupling, donut coupling, elastic coupling, flexible coupling, fluid coupling, gear coupling, grid coupling, hirth joints, hydrodynamic coupling, jaw coupling, magnetic coupling, Oldham coupling, sleeve coupling, tapered shaft lock, twin spring coupling, rag joint coupling, universal joints, or any combination thereof. As used in this disclosure an “aircraft” is vehicle that may fly by gaining support from the air. As a non-limiting example, aircraft may include airplanes, helicopters, airships, blimps, gliders, paramotors, and the like thereof. In an embodiment, mechanical coupling may be used to connect the ends of adjacent parts and/or objects of an electric aircraft. Further, in an embodiment, mechanical coupling may be used to join two pieces of rotating electric aircraft components.

Still referring to FIG. 1, propulsor may include a thrust element which may be integrated into the propulsor. The thrust element may include, without limitation, a device using moving or rotating foils, such as one or more rotors, an airscrew or propeller, a set of airscrews or propellers such as contra-rotating propellers, a moving or flapping wing, or the like. Further, a thrust element, for example, can include without limitation a marine propeller or screw, an impeller, a turbine, a pump-jet, a paddle or paddle-based device, or the like.

In an embodiment, and still referring to FIG. 1, downward directed propulsor 112 has a rotational axis offset from a vertical axis. As used in this disclosure a “rotational axis” is circular movement of a propeller about a vertical axis. For example, a propeller may revolve around a shaft, wherein the shaft is oriented along the vertical axis. In an embodiment a propeller may convert rotary motion from an engine or other power source into a swirling slipstream which pushes the propeller forwards or backwards. Propulsor may include a rotating power-driven hub, to which are attached several radial airfoil-section blades such that the whole assembly rotates about a longitudinal axis. As a non-limiting example. the blade pitch of the propellers may be fixed, manually variable to a few set positions, automatically variable (e.g. a “constant-speed” type), and/or any combination thereof. In an embodiment, propellers for an aircraft are designed to be fixed to their hub at an angle similar to the thread on a screw makes an angle to the shaft; this angle may be referred to as a pitch or pitch angle which will determine the speed of the forward movement as the blade rotates. Additionally or alternatively, downward directed propulsor has a rotational axis offset from a vertical axis by a yaw-torque-cancellation angle. As used in this disclosure a “yaw-torque-cancellation angle” is an angle at which one or more downward directed propulsors are oriented about the vertical axis to reduce and/or eliminate a yaw torque. As used in this disclosure a “yaw torque” is a torque exerted along the vertical axis of an aircraft, wherein the vertical axis has its origin at the center of gravity and is directed towards the bottom of the aircraft, perpendicular to the wings and to the fuselage reference line. As a non-limiting example a yaw torque directing the nose of an aircraft to the right of the vertical axis may be generated due to a rudder movement and/or shifting.

In an embodiment, and still referring to FIG. 1, yaw-torque-cancellation angle may include a nominal angle. As used in this disclosure a “nominal angle” is an angle of the propulsor in a horizontal axis. For example, and without limitation, a nominal angle may include a 3° angle tilted forward and/or a 3° angle tilted backward. Additionally or alternatively, yaw-torque-cancellation angle may include a canted angle. As used in this disclosure a “canted angle” is an angle of the propulsor in longitudinal direction. For example, and without limitation, a nominal angle may include a 5.5° angle tilted inward and/or a 5.5° angle tilted outward. In an embodiment, and without limitation, the plurality of downward directed propulsors 112 may be attached to fuselage 104 at a yaw-torque-cancellation angle that is a fixed angle. As used in this disclosure a “fixed angle” is an angle that is secured and/or unmovable from the attachment point. For example, and without limitation, a fixed angle may be an angle of 3.4° inward and/or 5.2° forward. As a further non-limiting example, a fixed angle may be an angle of 3 inward and/or 0.6° forward. In an embodiment the fixed angle may include the respective yaw-cancellation. For example, and without limitation, plurality of downward directed propulsor 112 may include a first downward directed propulsor having a first yaw-torque-cancellation angle with respect to the vertical axis and a second downward directed propulsor having a second yaw-cancelation angle with respect to the vertical axis. Additionally or alternatively, a first downward directed propulsor may be moveable to the yaw-torque-cancellation angle as a function of an actuator, wherein an actuator is described in detail below. For example, and without limitation a first downward directed propulsor may be angled at a first angle, wherein an actuator may rotate and/or shift the first downward directed propulsor to a yaw-torque-cancellation angle.

In an embodiment, and still referring to FIG. 1, yaw-torque-cancellation angle may include moving a flight component of the plurality of flight components due to a failure event, wherein a failure event is described in detail below. For example, and without limitation, yaw-torque-cancellation angle may include a shift, rotation, slider, switch, angular difference, and the like thereof for a downward director propulsor. As a non-limiting example, yaw-torque-cancellation angle may include shifting a rudder from a +2° angle about a vertical axis to a −6° angle about the vertical axis. As a further non-limiting example, a yaw-torque-cancellation angle may include rotating a tail rotor at a speed of 1944 RPMs to rotate the nose of the plane toward 8° to the right of a vertical axis in the yaw direction. As a further non-limiting example, yaw-torque-cancellation angle may include lifting an aileron from a closed state to an open state.

In an embodiment, and still referring to FIG. 1, aircraft 100 may include at least an actuator configured to move each propulsor of the plurality of downward directed propulsors 112. As used in this disclosure an “actuator” is a motor that may adjust an angle and/or position of a the downward directed propulsors. For example, and without limitation an actuator may adjust rotor 4° in the horizontal axis. As a further non, limiting example, an actuator may adjust an a propulsor from a first vertically aligned angle to a yaw-torque-cancellation angle. For example, downward directed propulsor 112 may be attached to fuselage 104 at a first vertical axis, wherein the first vertical axis may include a 3° inward and/or 1.4° forward wherein an actuator motor may maneuver and/or shift the downward directed propulsor +/−15° in the horizontal and/or longitudinal axis. In an embodiment, and without limitation, actuator may be commanded as a function of a flight controller. As used in this disclosure a “flight controller” is a computing device of a plurality of computing devices dedicated to data storage, security, distribution of traffic for load balancing, and flight instruction. Flight controller may include and/or communicate with any computing device as described in this disclosure, including without limitation a microcontroller, microprocessor, digital signal processor (DSP) and/or system on a chip (SoC) as described in this disclosure. Further, flight controller may include a single computing device operating independently, or may include two or more computing device operating in concert, in parallel, sequentially or the like; two or more computing devices may be included together in a single computing device or in two or more computing devices. In embodiments, flight controller may be installed in an aircraft, may control the aircraft remotely, and/or may include an element installed in the aircraft and a remote element in communication therewith.

In an embodiment, and still referring to FIG. 1, flight controller may include a reconfigurable hardware platform. A “reconfigurable hardware platform,” as used herein, is a component and/or unit of hardware that may be reprogrammed, such that, for instance, a data path between elements such as logic gates or other digital circuit elements may be modified to change an algorithm, state, logical sequence, or the like of the component and/or unit. This may be accomplished with such flexible high-speed computing fabrics as field-programmable gate arrays (FPGAs), which may include a grid of interconnected logic gates, connections between which may be severed and/or restored to program in modified logic. Reconfigurable hardware platform may be reconfigured to enact any algorithm and/or algorithm selection process received from another computing device and/or created using machine-learning and/or neural net processes as described below.

Still referring to FIG. 1, flight controller may include, be included in, and/or communicate with a mobile device such as a mobile telephone or smartphone. Further, flight controller may communicate with one or more additional devices as described below in further detail via a network interface device. The network interface device may be utilized for commutatively connecting a flight controller to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. The network may include any network topology and can may employ a wired and/or a wireless mode of communication.

In an embodiment, and still referring to FIG. 1, flight controller may include, but is not limited to, for example, a cluster of computing devices in a first location and a second computing device or cluster of computing devices in a second location. Flight controller may include one or more computing devices dedicated to data storage, security, distribution of traffic for load balancing, and the like. Flight controller may be configured to distribute one or more computing tasks as described below across a plurality of computing devices of computing device, which may operate in parallel, in series, redundantly, or in any other manner used for distribution of tasks or memory between computing devices. Flight controller may also be implemented using a “shared nothing” architecture in which data is cached at the worker, in an embodiment, this may enable scalability of aircraft 100 and/or computing device.

In an embodiment, and with continued reference to FIG. 1, flight controller may be designed and/or configured to perform any method, method step, or sequence of method steps in any embodiment described in this disclosure, in any order and with any degree of repetition. For instance, flight controller may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Flight controller may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, flight controller may be communicatively connected to a sensor. As used herein, “communicatively connecting” is a process whereby one device, component, or circuit is able to receive data from and/or transmit data to another device, component, or circuit. A communicative connection may be achieved through wired or wireless electronic communication, either directly or by way of one or more intervening devices or components. Further, communicative connecting can include electrically coupling at least an output of one device, component, or circuit to at least an input of another device, component, or circuit. For example, via a bus or other facility for intercommunication between elements of a computing device as described in this disclosure. Communicative connecting may also include indirect connections via wireless connection, radio communication, low power wide area network, optical communication, magnetic, capacitive, or optical coupling, or the like.

With continued reference to FIG. 1, a “sensor”, as used herein, is a device, module, and/or subsystem, utilizing any hardware, software, and/or any combination thereof to detect events and/or changes in the instant environment and transmit the information. Sensor may be attached via a mechanically and/or communicatively coupled, as described above, to aircraft 100. Sensor may be configured to detect a failure event of downward directed propulsor 112. Sensor may be communicatively connected to an energy source and/or motor, wherein sensor detects one or more conditions of the energy source and/or motor. One or more conditions may include, without limitation, voltage levels, electromotive force, current levels, temperature, current speed of rotation, and the like. Sensor may further include detecting electrical parameters. Electrical parameters may include, without limitation, voltage, current, ohmic resistance of a flight component. Sensor may include one or more environmental sensors, which may function to sense parameters of the environment surrounding the aircraft. An environmental sensor may include without limitation one or more sensors used to detect ambient temperature, barometric pressure, and/or air velocity, one or more motion sensors which may include without limitation gyroscopes, accelerometers, inertial measurement unit (IMU), and/or magnetic sensors, one or more humidity sensors, one or more oxygen sensors, or the like. Additionally or alternatively, sensor may include at least a geospatial sensor. Sensor may be located inside an aircraft; and/or be included in and/or attached to at least a portion of the aircraft. Sensor may include one or more proximity sensors, displacement sensors, vibration sensors, and the like thereof. Sensor may be used to monitor the status of aircraft 100 for both critical and non-critical functions. Sensor may be incorporated into vehicle or aircraft or be remote.

Still referring to FIG. 1, sensor may detect a failure event of downward directed propulsor 112 of the plurality of downward directed propulsors. As used in this disclosure a “failure event” is a failure of downward directed propulsor 112 of the plurality of downward directed propulsors. In an embodiment and without limitation, failure event 104 may include rotation degradation. As used in this disclosure “rotation degradation” is a reduced function of downward directed propulsor 112 such that a loss of control in the yaw axis occurs. As a non-limiting example, rotation degradation may occur due to a rotor in a quadrotor configuration that is not operating at the capacity necessary to maintain the flight plan, wherein the yaw portion of the torque exerted by the remaining rotors is not eliminated and an uncontrollable yaw axis torque is exerted. In a further embodiment and without limitation, failure event may include a propulsor that is not generating enough torque to maintain the flight plan. Sensor is further configured to generate a failure datum associated to the plurality of downward directed propulsors as a function of failure event. As used in this disclosure a “failure datum” is an element of data describing the failure of the downward directed propulsor that has occurred. As a non-limiting example, failure datum may be generated as a function of the determination that a propulsor, such as a rotor, is not generating torque, and/or that propulsor and/or rotor is generating less torque than expected and/or necessary to produce a level of thrust required to maintain airspeed and/or lift. As a further example, a degree of torque may be sensed, without limitation, utilizing load sensors deployed at and/or around a propulsor and/or by measuring back electromotive force (back EMF) generated by a motor driving the propulsor. Additionally or alternatively, failure datum may be generated as a function of the determination that one or more power sources is losing capacity to provide sufficient power to downward directed propulsor 112; this may be determined based on any suitable measure of an energy source capacity and/or output. For instance and without limitation, this may be detected by detection that one or more other downward directed propulsors are consuming less power is being provided to one or more components.

Still referring to FIG. 1, failure datum may be generated as a function of determining a failure event description. As used in this disclosure a “failure event description” is a description of the failure event that identifies a plurality of downward directed propulsors associated with a failure event. As a non-limiting example, failure event description may include identifying a rotor, propulsor, energy source, and the like thereof as a function of a failure event associated with reduced output. Failure datum may be generated as a function of the determination that plurality of downward directed propulsors 112 such as systems for directional control, wherein systems for directional control include systems that enable an aircraft to maintain a heading, direct itself in a direction as indicated by a flight plan, and/or modify direction to perform one or more flight maneuvers as described above, is unable to function correctly. For instance, where steering is directed using rudders and/or ailerons, failure datum may be generated as a function of the one or more rudders and/or ailerons are failing to move as required to effect teering commands; detection may include, without limitation, detection that servomotors or other motors controlling motion of such components, are not functioning, using back EMF, unexpectedly high and/or low amounts of impedance, measures of torque, and/or power and/or current consumption or the like, as above for motors propelling one or more propulsors. Detection may include detection of motion and/or lack thereof of a component such as an aileron and/or rudder using sensor that can detect motion. Detection of directional control failure, whether regulated by ailerons, rudders, and/or differential use of propulsors, may include a determination that expected shear stresses on the aircraft and/or one or more components thereof, as detected using load sensors, are less than they would be if the components were functioning correctly. Alternatively or additionally, detection may include detection that the aircraft is deviating from a route that would be expected if the steering components were functioning correctly.

Still referring to FIG. 1, failure datum 112 may be generated as a function of the determination that one or more power sources is losing capacity to provide sufficient power to downward directed propulsor 112; this may be determined based on any suitable measure of an energy source capacity and/or output. For instance, and without limitation, an output voltage of the energy source may reduce and/or collapse below a threshold level, a current output may reduce below a threshold level, and/or a detected internal resistance may increase unexpectedly. This may alternatively or additionally be detected by detection that one or more other downward directed propulsors are consuming less power and/or producing less thrust, torque, force, or the like, which may indicate that less power is being provided to one or more components. Sensor is further configured to generate a failure datum of the flight component of an aircraft as a function of the failure event. Failure datum may include, as an example and without limitation, a determination that a propulsor is damaged or otherwise operating insufficiently, such as without limitation a determination that a propulsor such as a propeller is not generating torque, and/or that the propulsor and/or propeller is generating less torque than expected and/or necessary to produce a level of thrust required to maintain airspeed and/or lift. As a further example a degree of torque may be sensed, without limitation, using load sensors deployed at and/or around a propulsor and/or by measuring back electromotive force (back EMF) generated by a motor driving the propulsor.

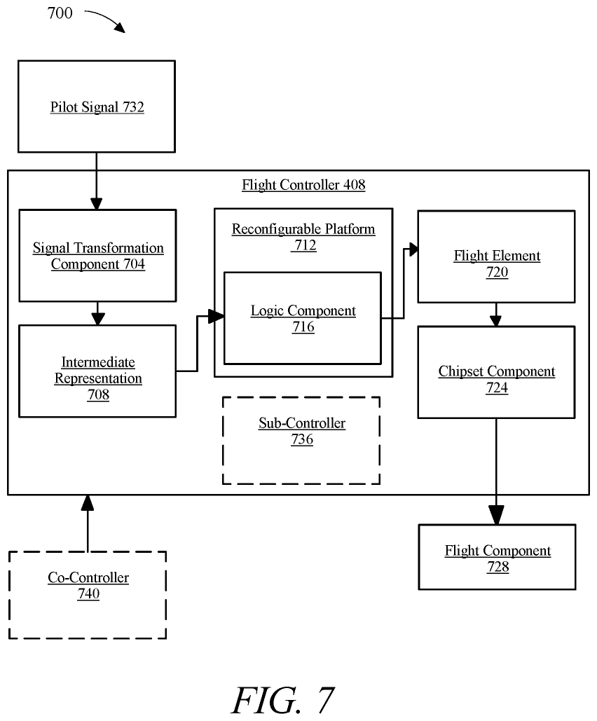

In an embodiment, and still referring to FIG. 1, flight controller may be configured to receive failure datum from the sensor associated with downward directed propulsor 112 and determine a corrective action for a flight component of the plurality of flight components as a function of the failure datum. As used in this disclosure a “corrective action” is an action conducted by the plurality of flight components to correct and/or alter a movement of an aircraft, wherein a flight component is a component that promotes flight and guidance of an aircraft as described below in detail. Corrective action may be determined as a function of reducing yaw torque generated by the downward directed propulsor. As used in this disclosure “yaw torque” is a torque exerted along the yaw axis of an aircraft. As a non-limiting example a yaw torque directing the nose of an aircraft to the right of a vertical axis may be generated due to a rudder movement and/or shifting. A flight component is a portion of an aircraft that can be moved or adjusted to affect altitude, airspeed velocity, groundspeed velocity or direction during flight, as described below in detail, in reference to FIG. 7. In an embodiment, flight controller may be communicatively coupled to the plurality of flight components. For example, plurality of flight components may include a component used to affect the aircrafts' roll and pitch which may comprise one or more ailerons, defined herein as hinged surfaces which form part of the trailing edge of each wing in a fixed wing aircraft, and which may be moved via mechanical means such as without limitation servomotors, mechanical linkages, or the like, to name a few. As a further example, the plurality of flight components may include a rudder, which may include, without limitation, a segmented rudder. The rudder may function, without limitation, to control yaw of an aircraft. The rudder may allow the aircraft to change in the horizontal direction, without altering the vertical direction. In an embodiment the rudder may include a rudder travel limiter. As used in this disclosure a “rudder travel limiter” is a maximum limit the rudder may be deflected. For example, a rudder may be limited to an angle of no more than 30°. Additionally or alternatively, the plurality of flight components may include other flight control surfaces such as propulsors, rotating flight controls, or any other structural features which can adjust the movement of the aircraft. In an embodiment, plurality of flight components may be oriented at a flight angle. As used in this disclosure a “flight angle” is an angle of the flight components to allow for flight capabilities. For example, and without limitation flight angle may be 7° for a first rotor, wherein the flight angle for a second rotor may be 7°.

Still referring to FIG. 1, plurality of flight components may include a tail rotor. As used in this disclosure a “tail rotor” is a smaller rotor mounted vertically and/or near-vertically at the tail of the aircraft. Tail rotor may rotate to generate a yaw thrust in the same direction as the main rotor's rotation. Tail rotor may be positioned at a distance from the aircrafts center of mass to allow for enough thrust and/or torque to rotate the aircraft in the yaw direction. Tail rotor may include an adjustable pitch. As used in this disclosure an “adjustable pitch” is a pitch of the tail rotor blades that may be varied to provide directional control of the tail rotor in the yaw axis. For example, and without limitation, the tail rotor may rotate an aircraft 3° in the positive direction of the yaw axis to maintain a flight path. In an embodiment, and without limitation, the tail rotor may be composed of a core made of aluminum honeycomb and/or plasticized paper honeycomb, covered in a skin made of aluminum, carbon fiber composite, and/or titanium. Tail rotor may be fixed and/or adjustable as a function of an actuator motor.

Still referring to FIG. 1, plurality of flight components may include a NOTAR. As used in this disclosure a “NOTAR” is a rotor that has no rotating parts in the open. The NOTAR may include an air intake located just behind the main cabin of the aircraft. The air intake may then be thrust towards the tail boom of the aircraft as a function of a NOTAR fan that blows compressed air through the tail boom. The NOTAR fan may be variably controlled to adjust the amount of air that is forced to the end of the tail boom in the aircraft. The compressed air that NOTAR may generate may an exhaust force out of a side of the tail boom. As used in this disclosure an “exhaust force” is a force that is expelled to provide directional control of the aircraft in the yaw axis. For example, and without limitation a NOTAR may expel an exhaust force out of the left side of the tail boom, wherein the tail boom moves in the yaw axis to the right, adjusting the nose of the aircraft to the left.

Still referring to FIG. 1, corrective action may be determined as a function of receiving a vertically aligned angle as a function of the sensors. As used in this disclosure a “vertically aligned angle” is a measurement of at least a force that share a common endpoint. Vertically aligned angle may include a measurement of a force in reference to a vertical axis, such as without limitation a vertical axis matching a vertical axis of the aircraft when at rest on the ground. Vertically aligned angle may be determined as a function of obtaining a yaw input. As used in this disclosure a “yaw input” is any input and/or datum that identifies a vertically aligned angle. For example, and without limitation, yaw input may be obtained as a function of a yaw detector. As used in this disclosure a “yaw detector” is one or more sensors that are capable of determining a vertically aligned angle, yaw velocity, and/or yaw acceleration. Yaw detector may measure the ground velocity at two geometrically separated points on the body of the aircraft. In an embodiment and without limitation, the yaw detector may include a gyroscope. As used in this disclosure a “gyroscope” is a detector that may measure orientation and/or angular velocity. For example, and without limitation, gyroscopes may include microchip-packaged MEMS gyroscopes, gyro meters, solid-state ring lasers, fiber optic gyroscopes, quantum gyroscopes, inertial navigation systems, gyrocompasses, and the like thereof. Additionally or alternatively, yaw detector may include a haltere component. As used in this disclosure a “haltere component” is a vibrating gyroscope that extends from the aircraft along the yaw axis. In an embodiment, and without limitation, haltere component may rapidly oscillate along the extensions to detect any rotation of the plane of oscillation as a function of a Coriolis effect. As used in this disclosure a “Coriolis effect” is an inertial and/or fictitious force that acts on objects that are in motion within a frame of reference that rotates with respect to an inertial frame. For example, and without limitation, one or more haltere components may determine a yaw axis direction as a function of the vibrating gyroscopes and the aircrafts yaw velocity.

In an embodiment, and still referring to FIG. 1, yaw detector may include an accelerometer. As used in this disclosure an “accelerometer” is a detector that measures proper acceleration. Accelerometers may measure proper acceleration as a function of measuring motion and/or vibration by converting physical movement into an electrical signal suitable for measurement, recording, analysis, and/or control. For example, and without limitation, accelerometers may exhibit a flat amplitude sensitivity and phase response with respect to frequency, and straight-line amplitude. As a further non-limiting example, accelerometers may include one or more inertial mass deflecting component, such as a beam and/or crystal, and/or an inertial sensing element. In an embodiment, and without limitation, accelerometers may measure proper acceleration of the aircraft and synthesis the yaw velocity as a function of the measured lateral acceleration of the aircraft at constant speed around a constant radius.

Still referring to FIG. 1, corrective action may identify a yaw-torque-cancellation angle as a function of the vertically aligned angle. As used in this disclosure a “yaw-torque-cancellation angle” is a movement of a flight component of the plurality of flight components due to a failure event. For example, and without limitation, yaw-torque-cancellation angle may include a shift, rotation, slider, switch, angular difference, and the like thereof for a downward director propulsor. As a non-limiting example, yaw-torque-cancellation angle may include shifting a rudder from a +2° angle about a vertical axis to a −6° angle about the vertical axis. As a further non-limiting example, a yaw-torque-cancellation angle may include rotating a tail rotor at a speed of 1944 RPMs to rotate the nose of the plane toward 8° to the right of a vertical axis in the yaw direction. As a further non-limiting example, yaw-torque-cancellation angle may include lifting an aileron from a closed state to an open state. Yaw-torque-cancellation angle may be identified as a function of receiving a yaw torque as a function of failure datum. Yaw-torque-cancellation angle may be identified by determining a nullification element as a function of the yaw torque. As used in this disclosure a “nullification element” is an element that eliminates a yaw torque, such that a net zero yaw torque is exerted on the aircraft. As a non-limiting example a nullification element may include forcing compressed air through a NOTAR to move the tail of the aircraft to a 12° angle off the vertical axis to correct a flight component failure such that the net yaw torque is zero. In an embodiment, and without limitation, yaw-torque-cancellation angle may be identified as a function of one or more external factors, wherein external factors include air speed, flight component movements, such as revolutions per minute, weather, altitude, and the like thereof.

In an embodiment and still referring to FIG. 1, identifying yaw-torque-cancellation angle may include identifying a corrective tilt. As used in this disclosure a “corrective tilt” is an angle and/or movement required to at least reduce and/or eliminate a yaw torque exerted on the aircraft. Corrective tilt may be moved and/or rotated as a function of a vertical axis that is perpendicular to the flight component. As a non-limiting example a corrective tilt may include rotating and/or shifting a rotor of a quadrotor configuration 3° towards the vertical axis to reduce the yaw torques exerted by the remaining three rotors. In an embodiment, and without limitation, corrective tilt may be identified as a function of one or more external factors, wherein external factors include air speed, flight component movements, such as revolutions per minute, weather, altitude, and the like thereof.

Still referring to FIG. 1, flight controller may command an actuator to perform corrective action. As a non-limiting example, commanding an actuator may include vectoring a longitudinal thrust flight component of the plurality of longitudinal thrust flight components. As used in this disclosure “vectoring” is a manipulation and/or alteration of the direction of thrust and/or action of a flight component. As a non-limiting example, vectoring a longitudinal thrust flight component may include shifting and/or rotating a propulsor to alter and/or change the direction of thrust generated by the propulsor. As a further non-limiting example, vectoring a longitudinal thrust flight component may include increasing and/or decreasing total power supplied to a propulsor to alter and/or change the force of thrust generated by the propulsor. As used in this disclosure a “longitudinal thrust flight component” is a flight component that is mounted such that the component thrusts the flight component through a medium. As a non-limiting example, longitudinal thrust flight component may include a pusher flight component such as a pusher propeller, a pusher motor, a pusher propulsor, and the like. Additionally, or alternatively, pusher flight component may include a plurality of pusher flight components. As a further non-limiting example, longitudinal thrust flight component may include a puller flight component such as a puller propeller, a puller motor, a puller propulsor, and the like. Additionally, or alternatively, puller flight component may include a plurality of puller flight components.

In an embodiment, and still referring to FIG. 1, performing corrective action may include vectoring a torque component of the plurality of torque components. As used in this disclosure a “torque component” is a component that generates a rotational torque and/or turning effect. For example, and without limitation a tail rotor may be a torque component, wherein a tail rotor may be capable of exerting a rotational torque on the aircraft about a vertical axis in the yaw direction. As a further non-limiting example, a torque component may include rudder, wherein a rudder may be shifted to at least exert a rotational torque on the aircraft about aircraft about a vertical axis in the yaw direction. In an embodiment, and without limitation a torque component may include a gyroscopic stabilizer. As used in this disclosure a “gyroscopic stabilizer” is a stabilizer that reduces the yaw torque of an aircraft. For example, and without limitation gyroscopic stabilizer may sense yaw torque as a function of a first sensing gyroscope, wherein a gyroscope is a detector that may measure orientation and/or angular velocity, as described above in detail, and counteract yaw torque as a function of adjusting control surfaces and/or applying torque to a second larger gyroscope, wherein the second large gyroscope may exert a corrective action on the aircraft.

With continued reference to FIG. 1, aircraft 100 may include an electric aircraft that flight controller may be programmed to operate an aircraft, including without limitation an electronic aircraft, to perform at a flight maneuver. A flight maneuver may include taxiing, takeoff, landing, stability control maneuvers, hovering, emergency response maneuvers, regulation of altitude, roll, pitch, yaw, speed, acceleration, or the like during any phase of flight. A flight maneuver may further include a flight plan or sequence of maneuvers to be performed during a flight plan. A flight maneuver can also include a change in altitude, change in speed, changed in travel direction, or the like. Further, a flight maneuver may include a landing, which may be a runway landing, defined herein as a landing in which a fixed-wing aircraft, or other aircraft that generates lift by moving a foil forward through air, flies forward toward a flat area of ground or water, alighting on the flat area and then moving forward until momentum is exhausted on wheels or (in the case of landing on water) pontoons. Momentum may be exhausted more rapidly by reverse thrust using propulsors, mechanical braking, electric braking, or the like. In an embodiment, a flight maneuver may include a vertical landing protocol, which may include a rotor-based landing such as one performed by rotorcraft such as helicopters or the like. In an embodiment, vertical takeoff and landing protocols may require greater expenditure of energy than runway-based landings. For example, vertical takeoff and landing protocols may, for instance, require substantial expenditure of energy to maintain a hover or near hover while descending or ascending, while the latter may require a net decrease in energy to approach or achieve stall. In an embodiment, flight controller may be designed and configured to operate an aircraft via fly-by-wire. Flight controller may enable fly-by-wire in response to an event or by the actions of others. In an embodiment, flight controller may command an aircraft to operate via fly-by-wire when a failure of a component is detected.

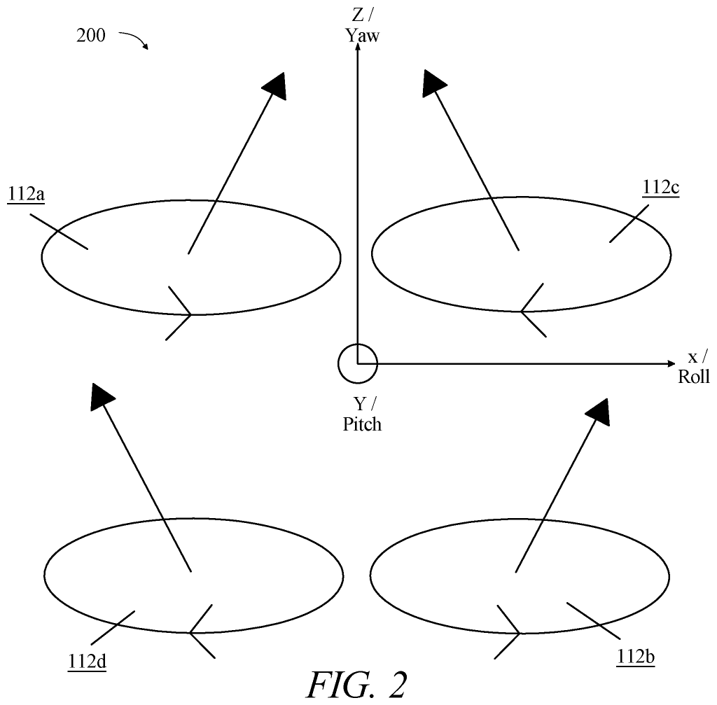

Now referring to FIG. 2, an embodiment of yaw-torque-cancellation angle 200 is displayed. A plurality of flight components 112a-d attached to an aircraft includes a first downward directed propulsor 112a and second downward directed propulsor 112b are rotating in a counter-clockwise direction. First downward directed propulsor 112a and second downward directed propulsor 112b are attached at a yaw-torque-cancellation angle to produce a yaw contribution along the roll axis in a positive direction. First downward directed propulsor 112a may include any first downward directed propulsor as described above in the entirety of this disclosure. Second downward directed propulsor 112b may include any second downward directed propulsor as described above in further detail. Further, in the embodiment, third downward directed propulsor 112c and fourth downward directed propulsor 112d are rotating in a clockwise direction. Third downward directed propulsor 112c and fourth downward directed propulsor 112d are attached at a yaw-torque-cancellation angle to produce yaw contribution along the roll axis in a negative direction. Third downward directed propulsor 112c may include any third downward directed propulsor as described above in further detail. Fourth downward directed propulsor 112d may include any fourth downward directed propulsor as described above in further detail in the entirety of this disclosure. In the embodiment, to control yaw of the aircraft, third downward directed propulsor 112c and fourth downward directed propulsor 104d to spin on the diagonal, such that pitch or roll torque is not coupled with yaw. Moreover, the sum of yaw contribution is negated as each rotor cancels the opposing yaw contributions of the subsequent rotors.

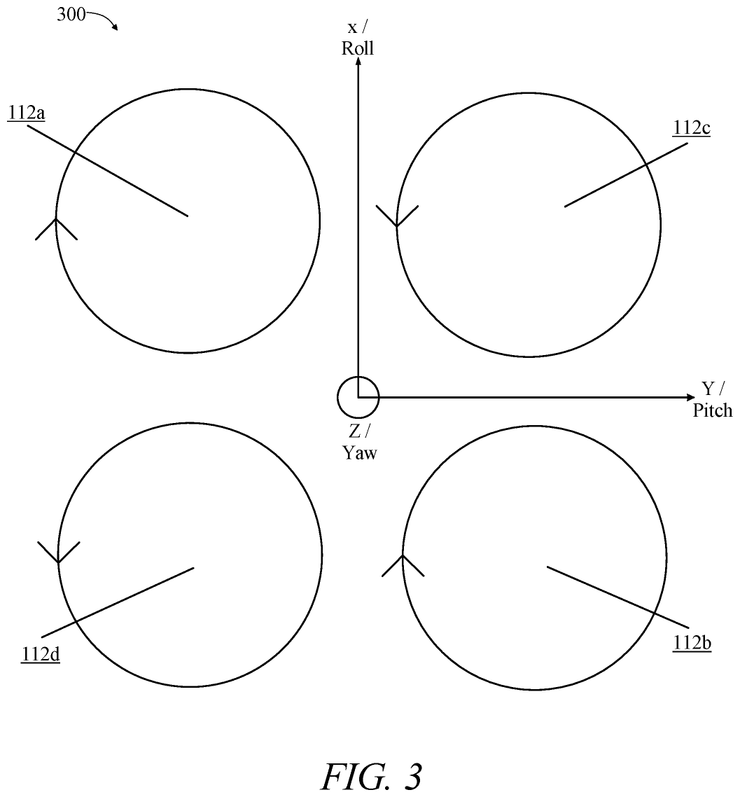

Referring now to FIG. 3, an embodiment 300 for self-neutralizing flight is displayed. A plurality of downward directed propulsors 112a-d attached to an aircraft includes a first downward directed propulsor 112a and second downward directed propulsor 112b that are rotating in a counter-clockwise direction. First downward directed propulsor 112a may include any first downward directed propulsor as described above in the entirety of this disclosure. Second downward directed propulsor 112b may include any second downward directed propulsor as described above in further detail. Further, in the embodiment, third downward directed propulsor 112c and fourth downward directed propulsor 112d are rotating in a clockwise direction. Third downward directed propulsor 112c may include any third downward directed propulsor as described above in further detail. Fourth downward directed propulsor 112d may include any fourth downward directed propulsor as described above in further detail in the entirety of this disclosure. In the embodiment, the sum of motor torques and thrust torques produced by first downward directed propulsor 112a, second downward directed propulsor 112b, third downward directed propulsor 112c, and fourth downward directed propulsor 112d provide the aircraft with roll, and pitch control. Further, in the embodiment, the sum of thrusts generated by first downward directed propulsor 112a, second downward directed propulsor 112b, third downward directed propulsor 112c, and fourth downward directed propulsor 112d provides the aircraft with heave, such as altitude control. In the embodiment, to control yaw of the aircraft, third downward directed propulsor 112c and fourth downward directed propulsor 112d to spin on the diagonal, such that pitch or roll torque is not coupled with yaw.

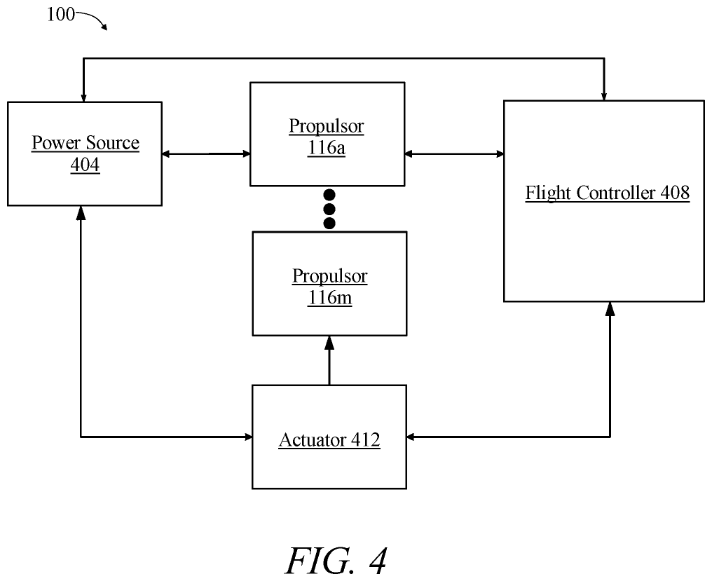

Referring now to FIG. 4, a block diagram of an exemplary embodiment of an aircraft for self-neutralizing flight 100 is illustrated. Aircraft 100 includes a power source 404, wherein a power source is a source that may propel a rotor, or set of airfoils, through a fluid medium, like air, generating life. As described above in detail. Power source 404 provides power to a plurality of downward directed propulsors 112a-m. Downward directed propulsor 112a-m includes any of the downward directed propulsor 112 as described above, in reference to FIGS. 1-3. The plurality of downward directed propulsors 112a-m may be controlled by a flight controller 408, wherein flight controller 408 is a computing device of a plurality of computing devices dedicated to data storage, security, distribution of traffic for load balancing, and flight instruction as described above in detail in reference to FIGS. 1-3. In an embodiment, and without limitation. flight controller 408 may receive power from power source 404. For example, and without limitation, flight controller 408 may include one or more flight management systems, control display units, electronic flight instrument systems, flight management computers, and the like thereof. Flight controller 408 may comment the plurality of downward directed propulsors 112a-m to rotate at a specific power, torque, speed, velocity, and the like thereof. Flight controller 408 may command plurality of downward directed propulsors 112a-m to accelerate and/or decelerate as a function of one or more flight paths. Additionally or alternatively, flight controller 408 may command an actuator 412, wherein an actuator 412 is a motor that may adjust an angle and/or position of a the downward directed propulsors as described above, in reference to FIGS. 1-3. In an embodiment, and without limitation, actuator 412 may receive power from power source 404. Actuator may rotate, shift, maneuver, and/or adjust the plurality of downward directed propulsors 112a-m as a function of flight controller 408. For example, and without limitation flight controller 408 may command actuator to rotate 6° in the horizontal axis, wherein actuator may then adjust the plurality of downward director propulsors 112a-m to rotate according to the movement of the actuator. As a further non-limiting example, flight controller 408 may command actuator to rotate 6° in the horizontal axis, wherein actuator may then adjust the plurality of downward director propulsors 112a-m to rotate according to the movement of the actuator.

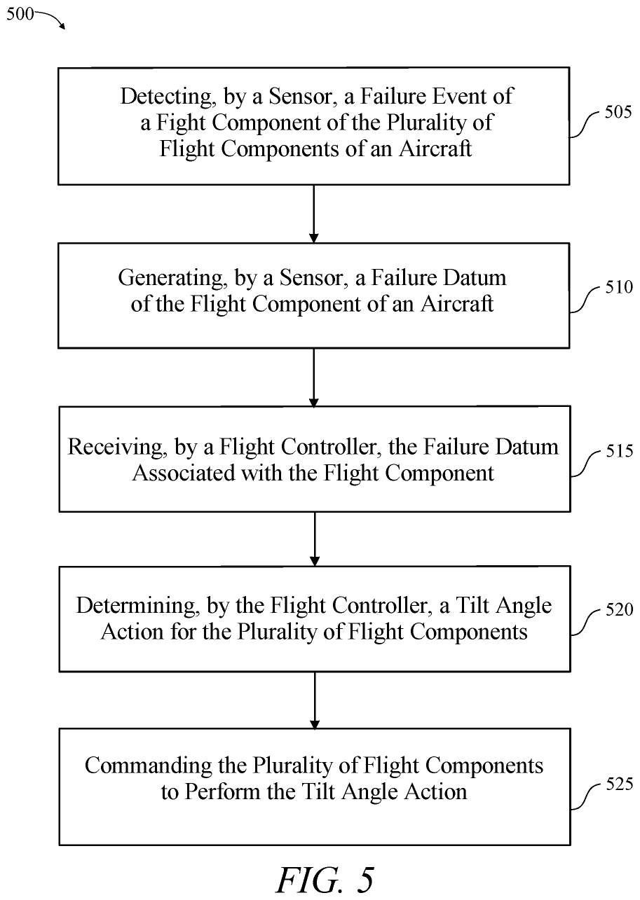

Now referring to FIG. 5, an exemplary embodiment for a method 500 for self-neutralizing flight is illustrated. At step 505, a sensor detects a failure event of a downward directed propulsor 112 of a plurality of downward directed propulsors. Sensor includes any of the sensor as described above, in reference to FIGS. 1-4. Failure event includes any of the failure event as described above, in reference to FIGS. 1-4. Plurality of downward directed propulsors 112 includes any of the plurality of downward directed propulsors 112 as described above, in reference to FIGS. 1-4.

Still referring to FIG. 5, at step 510, sensor generates a failure datum associated to the plurality of downward directed propulsors 112. Failure datum includes any of the failure datum as described above, in reference to FIGS. 1-4.

Still referring to FIG. 5, at step 515, a flight controller receives failure datum associated with the plurality of downward directed propulsors from sensor. Flight controller includes any of the flight controller as described above, in reference to FIGS. 1-4.

Still referring to FIG. 5, at step 520, flight controller determines a corrective action from a plurality of flight components and/or downward directed propulsor 112 as a function of failure datum. Corrective action includes any of the corrective action as described above, in reference to FIGS. 1-4. Plurality of flight components includes any of the plurality of flight components as described above, in reference to FIGS. 1-4.

Still referring to FIG. 5, at step 525, flight controller commands an actuator to perform corrective action on the plurality of flight components and/or downward directed propulsors 112. Actuator includes any of the actuator as described above, in reference to FIGS. 1-4.

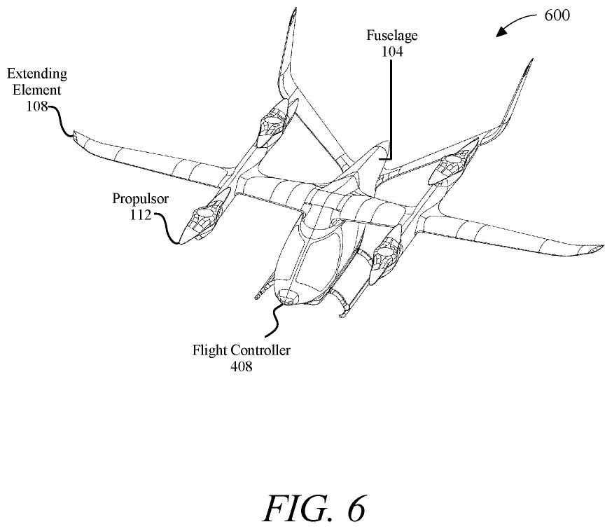

Now referring to FIG. 6, an exemplary embodiment for an aircraft 600 for neutralizing flight is illustrated. Aircraft 600 includes any of the aircraft as described above in reference to FIGS. 1-5. Aircraft 600 comprises a fuselage 104. Fuselage 104 includes any of the fuselage 104 as described above, in reference to FIGS. 1-5. Aircraft 600 comprises at least a power source located within fuselage 104. Power source includes any of the power source as described above, in reference to FIGS. 1-5. Aircraft 600 comprises a plurality of laterally extending elements 108 attached to fuselage 104. Laterally extending elements 108 includes any of the laterally extending elements 108 as described above, in reference to FIGS. 1-5. Aircraft 100 includes a plurality of downward directed propulsors 112 attached to the plurality of laterally extending elements 108. Downward directed propulsors include any of the downward directed propulsors 112 as described above, in reference to FIGS. 1-5. Plurality of downward directed propulsors 112 are electrically connected to the at least a power source, wherein the plurality of downward directed propulsors have a rotational axis offset from a vertical axis by a yaw-torque cancellation angle. Rotational axis includes any of the rotational axis as described above, in reference to FIGS. 1-5. Vertical axis includes any of the vertical axis as described above, in reference to FIGS. 1-5. Yaw-torque-cancellation angle includes any of the yaw-torque-cancellation angle as described above, in reference to FIGS. 1-5.

Still referring to FIG. 6, aircraft 600 comprises a flight controller 408. Flight controller 408 includes any of the flight controller 408 as described above, in reference to FIGS. 1-5. Flight controller 408 is configured to include a notification unit. As used in this disclosure a “notification unit” is a component capable of producing and/or emitting a notification and/or signal to a pilot. In an embodiment, and without limitation, notification unit may include a graphical user interface (GUI). For the purposes of this disclosure, a “graphical user interface” is a device configured to present data or information in a visual manner to a pilot, computer, camera or combination thereof. Notification unit may be configured to display information regarding aircraft 600. Notification unit may be configured to display information regarding a failure of a flight component and/or a failure of an energy source. Notification unit may prompt a pilot to input a pilot signal as a function of a required interaction and/or response, wherein a pilot signal is an element of datum representing one or more functions a pilot is controlling and/or adjusting as described below in reference to FIG. 7. Notification unit may be configured to receive haptic, audio, visual, gesture, passkey, or other type of interaction from the pilot. Notification unit may perform one or more functions in response to the interaction from the pilot. In non-limiting examples, and without limitation, notification unit may transmit pilot signal to flight controller 408 when an affirmative interaction is received from the pilot, the signal indicating to transmit one or more signals to other components communicatively connected thereto, such as a flight component, wherein a flight component is a portion of an aircraft that can be moved or adjusted to affect one or more flight elements, as described below in reference to FIG. 7. As a further non-limiting example, notification unit may transmit pilot signal to flight controller 408 as a function of a pilot denying and/or refusing to perform the tilt angle action, wherein the tilt angle action is described above, in reference to FIGS. 1-5. In an embodiment, and without limitation, flight controller 408 may determine a tilt angle action and transmit a notification as a function of notification unit to at least receive a pilot signal and/or interaction. For example, and without limitation, notification unit may transmit a notification that requires a pilot's approval and/or denial of a tilt angle action prior to command the plurality of flight components to perform the tilt angle action. Notification unit may operate independent to flight controller 408 and any other component communicatively connected thereto. For example and without limitation, notification unit may indicate to the pilot that an energy source has a certain level of charge and aircraft 600 may operate autonomously to adjust one or more electrical commands regardless of the notification to the pilot. In an embodiment, and without limitation, flight controller 408 may command flight component to perform the tilt angle action as a function of pilot signal 432. Tilt angle action includes any of the tilt angle action as described above, in reference to FIGS. 1-5.

Now referring to FIG. 7, an exemplary embodiment 700 of a flight controller 408 is illustrated, wherein a flight controller is a computing device of a plurality of computing devices dedicated to data storage, security, distribution of traffic for load balancing, and flight instruction as described above, in reference to FIGS. 1-6. Flight controller 408 may include and/or communicate with any computing device as described in this disclosure, including without limitation a microcontroller, microprocessor, digital signal processor (DSP) and/or system on a chip (SoC) as described in this disclosure. Further, flight controller 408 may include a single computing device operating independently, or may include two or more computing device operating in concert, in parallel, sequentially or the like; two or more computing devices may be included together in a single computing device or in two or more computing devices. In embodiments, flight controller 408 may be installed in an aircraft, may control the aircraft remotely, and/or may include an element installed in the aircraft and a remote element in communication therewith.

In an embodiment, and still referring to FIG. 7, flight controller 408 may include a signal transformation component 704. As used in this disclosure a “signal transformation component” is a component that transforms and/or converts a first signal to a second signal, wherein a signal may include one or more digital and/or analog signals. For example, and without limitation, signal transformation component 704 may be configured to perform one or more operations such as preprocessing, lexical analysis, parsing, semantic analysis, and the like thereof. In an embodiment, and without limitation, signal transformation component 704 may include one or more analog-to-digital convertors that transform a first signal of an analog signal to a second signal of a digital signal. For example, and without limitation, an analog-to-digital converter may convert an analog input signal to a 10-bit binary digital representation of that signal. In another embodiment, signal transformation component 704 may include transforming one or more low-level languages such as, but not limited to, machine languages and/or assembly languages. For example, and without limitation, signal transformation component 704 may include transforming a binary language signal to an assembly language signal. In an embodiment, and without limitation, signal transformation component 704 may include transforming one or more high-level languages and/or formal languages such as but not limited to alphabets, strings, and/or languages. For example, and without limitation, high-level languages may include one or more system languages, scripting languages, domain-specific languages, visual languages, esoteric languages, and the like thereof. As a further non-limiting example, high-level languages may include one or more algebraic formula languages, business data languages, string and list languages, object-oriented languages, and the like thereof.

Still referring to FIG. 7, signal transformation component 704 may be configured to optimize an intermediate representation 708. As used in this disclosure an “intermediate representation” is a data structure and/or code that represents the input signal. Signal transformation component 704 may optimize intermediate representation as a function of a data-flow analysis, dependence analysis, alias analysis, pointer analysis, escape analysis, and the like thereof. In an embodiment, and without limitation, signal transformation component 704 may optimize intermediate representation 708 as a function of one or more inline expansions, dead code eliminations, constant propagation, loop transformations, and/or automatic parallelization functions. In another embodiment, signal transformation component 704 may optimize intermediate representation as a function of a machine dependent optimization such as a peephole optimization, wherein a peephole optimization may rewrite short sequences of code into more efficient sequences of code. Signal transformation component 704 may optimize intermediate representation to generate an output language, wherein an “output language,” as used herein, is the native machine language of flight controller 408. For example, and without limitation, native machine language may include one or more binary and/or numerical languages.

In an embodiment, and without limitation, signal transformation component 704 may include transform one or more inputs and outputs as a function of an error correction code. An error correction code, also known as error correcting code (ECC), is an encoding of a message or lot of data using redundant information, permitting recovery of corrupted data. An ECC may include a block code, in which information is encoded on fixed-size packets and/or blocks of data elements such as symbols of predetermined size, bits, or the like. Reed-Solomon coding, in which message symbols within a symbol set having q symbols are encoded as coefficients of a polynomial of degree less than or equal to a natural number k, over a finite field F with q elements; strings so encoded have a minimum hamming distance of k+1, and permit correction of (q-k−1)/2 erroneous symbols. Block code may alternatively or additionally be implemented using Golay coding, also known as binary Golay coding, Bose-Chaudhuri, Hocquenghuem (BCH) coding, multidimensional parity-check coding, and/or Hamming codes. An ECC may alternatively or additionally be based on a convolutional code.

In an embodiment, and still referring to FIG. 7, flight controller 408 may include a reconfigurable hardware platform 712. A “reconfigurable hardware platform,” as used herein, is a component and/or unit of hardware that may be reprogrammed, such that, for instance, a data path between elements such as logic gates or other digital circuit elements may be modified to change an algorithm, state, logical sequence, or the like of the component and/or unit. This may be accomplished with such flexible high-speed computing fabrics as field-programmable gate arrays (FPGAs), which may include a grid of interconnected logic gates, connections between which may be severed and/or restored to program in modified logic. Reconfigurable hardware platform 712 may be reconfigured to enact any algorithm and/or algorithm selection process received from another computing device and/or created using machine-learning processes.

Still referring to FIG. 7, reconfigurable hardware platform 712 may include a logic component 716. As used in this disclosure a “logic component” is a component that executes instructions on output language. For example, and without limitation, logic component may perform basic arithmetic, logic, controlling, input/output operations, and the like thereof. Logic component 716 may include any suitable processor, such as without limitation a component incorporating logical circuitry for performing arithmetic and logical operations, such as an arithmetic and logic unit (ALU), which may be regulated with a state machine and directed by operational inputs from memory and/or sensors; logic component 716 may be organized according to Von Neumann and/or Harvard architecture as a non-limiting example. Logic component 716 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC). In an embodiment, logic component 716 may include one or more integrated circuit microprocessors, which may contain one or more central processing units, central processors, and/or main processors, on a single metal-oxide-semiconductor chip. Logic component 716 may be configured to execute a sequence of stored instructions to be performed on the output language and/or intermediate representation 708. Logic component 716 may be configured to fetch and/or retrieve the instruction from a memory cache, wherein a “memory cache,” as used in this disclosure, is a stored instruction set on flight controller 408. Logic component 716 may be configured to decode the instruction retrieved from the memory cache to opcodes and/or operands. Logic component 716 may be configured to execute the instruction on intermediate representation 708 and/or output language. For example, and without limitation, logic component 716 may be configured to execute an addition operation on intermediate representation 708 and/or output language.

In an embodiment, and without limitation, logic component 716 may be configured to calculate a flight element 720. As used in this disclosure a “flight element” is an element of datum denoting a relative status of aircraft. For example, and without limitation, flight element 720 may denote one or more torques, thrusts, airspeed velocities, forces, altitudes, groundspeed velocities, directions during flight, directions facing, forces, orientations, and the like thereof. For example, and without limitation, flight element 720 may denote that aircraft is cruising at an altitude and/or with a sufficient magnitude of forward thrust. As a further non-limiting example, flight status may denote that is building thrust and/or groundspeed velocity in preparation for a takeoff. As a further non-limiting example, flight element 720 may denote that aircraft is following a flight path accurately and/or sufficiently.

Still referring to FIG. 7, flight controller 408 may include a chipset component 724. As used in this disclosure a “chipset component” is a component that manages data flow. In an embodiment, and without limitation, chipset component 724 may include a northbridge data flow path, wherein the northbridge dataflow path may manage data flow from logic component 716 to a high-speed device and/or component, such as a RAM, graphics controller, and the like thereof. In another embodiment, and without limitation, chipset component 724 may include a southbridge data flow path, wherein the southbridge dataflow path may manage data flow from logic component 716 to lower-speed peripheral buses, such as a peripheral component interconnect (PCI), industry standard architecture (ICA), and the like thereof. In an embodiment, and without limitation, southbridge data flow path may include managing data flow between peripheral connections such as ethernet, USB, audio devices, and the like thereof. Additionally or alternatively, chipset component 724 may manage data flow between logic component 716, memory cache, and a flight component 728. As used in this disclosure a “flight component” is a portion of an aircraft that can be moved or adjusted to affect one or more flight elements. For example, flight component728 may include a component used to affect the aircrafts' roll and pitch which may comprise one or more ailerons. As a further example, flight component 728 may include a rudder to control yaw of an aircraft. In an embodiment, chipset component 724 may be configured to communicate with a plurality of flight components as a function of flight element 720. For example, and without limitation, chipset component 724 may transmit to an aircraft rotor to reduce torque of a first lift propulsor and increase the forward thrust produced by a pusher component to perform a flight maneuver.

In an embodiment, and still referring to FIG. 7, flight controller 408 may be configured generate an autonomous function. As used in this disclosure an “autonomous function” is a mode and/or function of flight controller 408 that controls aircraft automatically. For example, and without limitation, autonomous function may perform one or more aircraft maneuvers, take offs, landings, altitude adjustments, flight leveling adjustments, turns, climbs, and/or descents. As a further non-limiting example, autonomous function may adjust one or more airspeed velocities, thrusts, torques, and/or groundspeed velocities. As a further non-limiting example, autonomous function may perform one or more flight path corrections and/or flight path modifications as a function of flight element 720. In an embodiment, autonomous function may include one or more modes of autonomy such as, but not limited to, autonomous mode, semi-autonomous mode, and/or non-autonomous mode. As used in this disclosure “autonomous mode” is a mode that automatically adjusts and/or controls aircraft and/or the maneuvers of aircraft in its entirety. For example, autonomous mode may denote that flight controller 408 will adjust the aircraft. As used in this disclosure a “semi-autonomous mode” is a mode that automatically adjusts and/or controls a portion and/or section of aircraft. For example, and without limitation, semi-autonomous mode may denote that a pilot will control the propulsors, wherein flight controller 408 will control the ailerons and/or rudders. As used in this disclosure “non-autonomous mode” is a mode that denotes a pilot will control aircraft and/or maneuvers of aircraft in its entirety.

In an embodiment, and still referring to FIG. 7, flight controller 408 may generate autonomous function as a function of an autonomous machine-learning model. As used in this disclosure an “autonomous machine-learning model” is a machine-learning model to produce an autonomous function output given flight element 720 and a pilot signal 732 as inputs; this is in contrast to a non-machine learning software program where the commands to be executed are determined in advance by a user and written in a programming language. As used in this disclosure a “pilot signal” is an element of datum representing one or more functions a pilot is controlling and/or adjusting. For example, pilot signal 732 may denote that a pilot is controlling and/or maneuvering ailerons, wherein the pilot is not in control of the rudders and/or propulsors. In an embodiment, pilot signal 732 may include an implicit signal and/or an explicit signal. For example, and without limitation, pilot signal 732 may include an explicit signal, wherein the pilot explicitly states there is a lack of control and/or desire for autonomous function. As a further non-limiting example, pilot signal 732 may include an explicit signal directing flight controller 408 to control and/or maintain a portion of aircraft, a portion of the flight plan, the entire aircraft, and/or the entire flight plan. As a further non-limiting example, pilot signal 732 may include an implicit signal, wherein flight controller 408 detects a lack of control such as by a malfunction, torque alteration, flight path deviation, and the like thereof. In an embodiment, and without limitation, pilot signal 732 may include one or more explicit signals to reduce torque, and/or one or more implicit signals that torque may be reduced due to reduction of airspeed velocity. In an embodiment, and without limitation, pilot signal 732 may include one or more local and/or global signals. For example, and without limitation, pilot signal 732 may include a local signal that is transmitted by a pilot and/or crew member. As a further non-limiting example, pilot signal 732 may include a global signal that is transmitted by air traffic control and/or one or more remote users that are in communication with the pilot of aircraft. In an embodiment, pilot signal 732 may be received as a function of a tri-state bus and/or multiplexor that denotes an explicit pilot signal should be transmitted prior to any implicit or global pilot signal.

Still referring to FIG. 7, autonomous machine-learning model may include one or more autonomous machine-learning processes such as supervised, unsupervised, or reinforcement machine-learning processes that flight controller 408 and/or a remote device may or may not use in the generation of autonomous function. As used in this disclosure “remote device” is an external device to flight controller 408. Additionally or alternatively, autonomous machine-learning model may include one or more autonomous machine-learning processes that a field-programmable gate array (FPGA) may or may not use in the generation of autonomous function. Autonomous machine-learning process may include, without limitation machine learning processes such as simple linear regression, multiple linear regression, polynomial regression, support vector regression, ridge regression, lasso regression, elasticnet regression, decision tree regression, random forest regression, logistic regression, logistic classification, K-nearest neighbors, support vector machines, kernel support vector machines, naive bayes, decision tree classification, random forest classification, K-means clustering, hierarchical clustering, dimensionality reduction, principal component analysis, linear discriminant analysis, kernel principal component analysis, Q-learning, State Action Reward State Action (SARSA), Deep-Q network, Markov decision processes, Deep Deterministic Policy Gradient (DDPG), or the like thereof.

In an embodiment, and still referring to FIG. 7, autonomous machine learning model may be trained as a function of autonomous training data, wherein autonomous training data may correlate a flight element, pilot signal, and/or simulation data to an autonomous function. For example, and without limitation, a flight element of an airspeed velocity, a pilot signal of limited and/or no control of propulsors, and a simulation data of required airspeed velocity to reach the destination may result in an autonomous function that includes a semi-autonomous mode to increase thrust of the propulsors. Autonomous training data may be received as a function of user-entered valuations of flight elements, pilot signals, simulation data, and/or autonomous functions. Flight controller 408 may receive autonomous training data by receiving correlations of flight element, pilot signal, and/or simulation data to an autonomous function that were previously received and/or determined during a previous iteration of generation of autonomous function. Autonomous training data may be received by one or more remote devices and/or FPGAs that at least correlate a flight element, pilot signal, and/or simulation data to an autonomous function. Autonomous training data may be received in the form of one or more user-entered correlations of a flight element, pilot signal, and/or simulation data to an autonomous function.

Still referring to FIG. 7, flight controller 408 may receive autonomous machine-learning model from a remote device and/or FPGA that utilizes one or more autonomous machine learning processes, wherein a remote device and an FPGA is described above in detail. For example, and without limitation, a remote device may include a computing device, external device, processor, FPGA, microprocessor and the like thereof. Remote device and/or FPGA may perform the autonomous machine-learning process using autonomous training data to generate autonomous function and transmit the output to flight controller 408. Remote device and/or FPGA may transmit a signal, bit, datum, or parameter to flight controller 408 that at least relates to autonomous function. Additionally or alternatively, the remote device and/or FPGA may provide an updated machine-learning model. For example, and without limitation, an updated machine-learning model may be comprised of a firmware update, a software update, an autonomous machine-learning process correction, and the like thereof. As a non-limiting example a software update may incorporate a new simulation data that relates to a modified flight element. Additionally or alternatively, the updated machine learning model may be transmitted to the remote device and/or FPGA, wherein the remote device and/or FPGA may replace the autonomous machine-learning model with the updated machine-learning model and generate the autonomous function as a function of the flight element, pilot signal, and/or simulation data using the updated machine-learning model. The updated machine-learning model may be transmitted by the remote device and/or FPGA and received by flight controller 408 as a software update, firmware update, or corrected autonomous machine-learning model. For example, and without limitation autonomous machine learning model may utilize a neural net machine-learning process, wherein the updated machine-learning model may incorporate a gradient boosting machine-learning process.

Still referring to FIG. 7, flight controller 408 may include, be included in, and/or communicate with a mobile device such as a mobile telephone or smartphone. Further, flight controller may communicate with one or more additional devices as described below in further detail via a network interface device. The network interface device may be utilized for commutatively connecting a flight controller to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. The network may include any network topology and can may employ a wired and/or a wireless mode of communication.

In an embodiment, and still referring to FIG. 7, flight controller 408 may include, but is not limited to, for example, a cluster of flight controllers in a first location and a second flight controller or cluster of flight controllers in a second location. Flight controller 408 may include one or more flight controllers dedicated to data storage, security, distribution of traffic for load balancing, and the like. Flight controller 408 may be configured to distribute one or more computing tasks as described below across a plurality of flight controllers, which may operate in parallel, in series, redundantly, or in any other manner used for distribution of tasks or memory between computing devices. For example, and without limitation, flight controller 408 may implement a control algorithm to distribute and/or command the plurality of flight controllers. As used in this disclosure a “control algorithm” is a finite sequence of well-defined computer implementable instructions that may determine the flight component of the plurality of flight components to be adjusted. For example, and without limitation, control algorithm may include one or more algorithms that reduce and/or prevent aviation asymmetry. As a further non-limiting example, control algorithms may include one or more models generated as a function of a software including, but not limited to Simulink by MathWorks, Natick, Massachusetts, USA. In an embodiment, and without limitation, control algorithm may be configured to generate an auto-code, wherein an “auto-code,” is used herein, is a code and/or algorithm that is generated as a function of the one or more models and/or software's. In another embodiment, control algorithm may be configured to produce a segmented control algorithm. As used in this disclosure a “segmented control algorithm” is control algorithm that has been separated and/or parsed into discrete sections. For example, and without limitation, segmented control algorithm may parse control algorithm into two or more segments, wherein each segment of control algorithm may be performed by one or more flight controllers operating on distinct flight components.

In an embodiment, and still referring to FIG. 7, control algorithm may be configured to determine a segmentation boundary as a function of segmented control algorithm. As used in this disclosure a “segmentation boundary” is a limit and/or delineation associated with the segments of the segmented control algorithm. For example, and without limitation, segmentation boundary may denote that a segment in the control algorithm has a first starting section and/or a first ending section. As a further non-limiting example, segmentation boundary may include one or more boundaries associated with an ability of flight component 728. In an embodiment, control algorithm may be configured to create an optimized signal communication as a function of segmentation boundary. For example, and without limitation, optimized signal communication may include identifying the discrete timing required to transmit and/or receive the one or more segmentation boundaries. In an embodiment, and without limitation, creating optimized signal communication further comprises separating a plurality of signal codes across the plurality of flight controllers. For example, and without limitation the plurality of flight controllers may include one or more formal networks, wherein formal networks transmit data along an authority chain and/or are limited to task-related communications. As a further non-limiting example, communication network may include informal networks, wherein informal networks transmit data in any direction. In an embodiment, and without limitation, the plurality of flight controllers may include a chain path, wherein a “chain path,” as used herein, is a linear communication path comprising a hierarchy that data may flow through. In an embodiment, and without limitation, the plurality of flight controllers may include an all-channel path, wherein an “all-channel path,” as used herein, is a communication path that is not restricted to a particular direction. For example, and without limitation, data may be transmitted upward, downward, laterally, and the like thereof. In an embodiment, and without limitation, the plurality of flight controllers may include one or more neural networks that assign a weighted value to a transmitted datum. For example, and without limitation, a weighted value may be assigned as a function of one or more signals denoting that a flight component is malfunctioning and/or in a failure state.

Still referring to FIG. 7, the plurality of flight controllers may include a master bus controller. As used in this disclosure a “master bus controller” is one or more devices and/or components that are connected to a bus to initiate a direct memory access transaction, wherein a bus is one or more terminals in a bus architecture. Master bus controller may communicate using synchronous and/or asynchronous bus control protocols. In an embodiment, master bus controller may include flight controller 408. In another embodiment, master bus controller may include one or more universal asynchronous receiver-transmitters (UART). For example, and without limitation, master bus controller may include one or more bus architectures that allow a bus to initiate a direct memory access transaction from one or more buses in the bus architectures. As a further non-limiting example, master bus controller may include one or more peripheral devices and/or components to communicate with another peripheral device and/or component and/or the master bus controller. In an embodiment, master bus controller may be configured to perform bus arbitration. As used in this disclosure “bus arbitration” is method and/or scheme to prevent multiple buses from attempting to communicate with and/or connect to master bus controller. For example and without limitation, bus arbitration may include one or more schemes such as a small computer interface system, wherein a small computer interface system is a set of standards for physical connecting and transferring data between peripheral devices and master bus controller by defining commands, protocols, electrical, optical, and/or logical interfaces. In an embodiment, master bus controller may receive intermediate representation 708 and/or output language from logic component 716, wherein output language may include one or more analog-to-digital conversions, low bit rate transmissions, message encryptions, digital signals, binary signals, logic signals, analog signals, and the like thereof described above in detail.

Still referring to FIG. 7, master bus controller may communicate with a slave bus. As used in this disclosure a “slave bus” is one or more peripheral devices and/or components that initiate a bus transfer. For example, and without limitation, slave bus may receive one or more controls and/or asymmetric communications from master bus controller, wherein slave bus transfers data stored to master bus controller. In an embodiment, and without limitation, slave bus may include one or more internal buses, such as but not limited to a/an internal data bus, memory bus, system bus, front-side bus, and the like thereof. In another embodiment, and without limitation, slave bus may include one or more external buses such as external flight controllers, external computers, remote devices, printers, aircraft computer systems, flight control systems, and the like thereof.

In an embodiment, and still referring to FIG. 7, control algorithm may optimize signal communication as a function of determining one or more discrete timings. For example, and without limitation master bus controller may synchronize timing of the segmented control algorithm by injecting high priority timing signals on a bus of the master bus control. As used in this disclosure a “high priority timing signal” is information denoting that the information is important. For example, and without limitation, high priority timing signal may denote that a section of control algorithm is of high priority and should be analyzed and/or transmitted prior to any other sections being analyzed and/or transmitted. In an embodiment, high priority timing signal may include one or more priority packets. As used in this disclosure a “priority packet” is a formatted unit of data that is communicated between the plurality of flight controllers. For example, and without limitation, priority packet may denote that a section of control algorithm should be used and/or is of greater priority than other sections.

Still referring to FIG. 7, flight controller 408 may also be implemented using a “shared nothing” architecture in which data is cached at the worker, in an embodiment, this may enable scalability of aircraft and/or computing device. Flight controller 408 may include a distributer flight controller. As used in this disclosure a “distributer flight controller” is a component that adjusts and/or controls a plurality of flight components as a function of a plurality of flight controllers. For example, distributer flight controller may include a flight controller that communicates with a plurality of additional flight controllers and/or clusters of flight controllers. In an embodiment, distributed flight control may include one or more neural networks. For example, neural network also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes, one or more intermediate layers, and an output layer of nodes. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 7, a node may include, without limitation a plurality of inputs xi that may receive numerical values from inputs to a neural network containing the node and/or from other nodes. Node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above. In an embodiment, and without limitation, a neural network may receive semantic units as inputs and output vectors representing such semantic units according to weights wᵢ that are derived using machine-learning processes as described in this disclosure.

Still referring to FIG. 7, flight controller may include a sub-controller 736. As used in this disclosure a “sub-controller” is a controller and/or component that is part of a distributed controller as described above; for instance, flight controller 408 may be and/or include a distributed flight controller made up of one or more sub-controllers. For example, and without limitation, sub-controller 736 may include any controllers and/or components thereof that are similar to distributed flight controller and/or flight controller as described above. Sub-controller 736 may include any component of any flight controller as described above. Sub-controller 736 may be implemented in any manner suitable for implementation of a flight controller as described above. As a further non-limiting example, sub-controller 736 may include one or more processors, logic components and/or computing devices capable of receiving, processing, and/or transmitting data across the distributed flight controller as described above. As a further non-limiting example, sub-controller 736 may include a controller that receives a signal from a first flight controller and/or first distributed flight controller component and transmits the signal to a plurality of additional sub-controllers and/or flight components.

Still referring to FIG. 7, flight controller may include a co-controller 740. As used in this disclosure a “co-controller” is a controller and/or component that joins flight controller 408 as components and/or nodes of a distributer flight controller as described above. For example, and without limitation, co-controller 740 may include one or more controllers and/or components that are similar to flight controller 408. As a further non-limiting example, co-controller 740 may include any controller and/or component that joins flight controller 408 to distributer flight controller. As a further non-limiting example, co-controller 740 may include one or more processors, logic components and/or computing devices capable of receiving, processing, and/or transmitting data to and/or from flight controller 408 to distributed flight control system. Co-controller 740 may include any component of any flight controller as described above. Co-controller 740 may be implemented in any manner suitable for implementation of a flight controller as described above.

In an embodiment, and with continued reference to FIG. 7, flight controller 408 may be designed and/or configured to perform any method, method step, or sequence of method steps in any embodiment described in this disclosure, in any order and with any degree of repetition. For instance, flight controller 408 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Flight controller may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

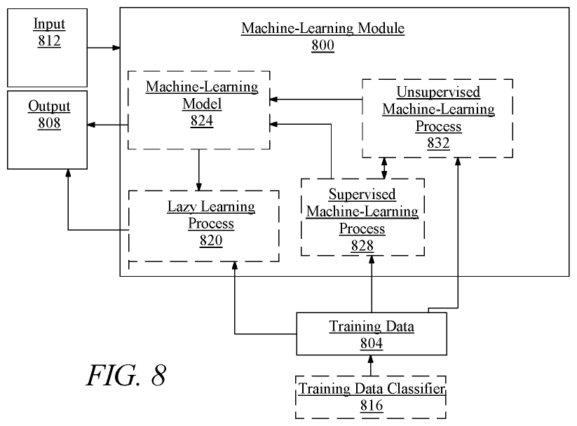

Referring now to FIG. 8, an exemplary embodiment of a machine-learning module 800 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 804 to generate an algorithm that will be performed by a computing device/module to produce outputs 808 given data provided as inputs 812; this is in contrast to a non-machine learning software program where the commands to be executed are determined in advance by a user and written in a programming language.

Still referring to FIG. 8, “training data,” as used herein, is data containing correlations that a machine-learning process may use to model relationships between two or more categories of data elements. For instance, and without limitation, training data 804 may include a plurality of data entries, each entry representing a set of data elements that were recorded, received, and/or generated together; data elements may be correlated by shared existence in a given data entry, by proximity in a given data entry, or the like. Multiple data entries in training data 804 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 804 according to various correlations; correlations may indicate causative and/or predictive links between categories of data elements, which may be modeled as relationships such as mathematical relationships by machine-learning processes as described in further detail below. Training data 804 may be formatted and/or organized by categories of data elements, for instance by associating data elements with one or more descriptors corresponding to categories of data elements. As a non-limiting example, training data 804 may include data entered in standardized forms by persons or processes, such that entry of a given data element in a given field in a form may be mapped to one or more descriptors of categories. Elements in training data 804 may be linked to descriptors of categories by tags, tokens, or other data elements; for instance, and without limitation, training data 804 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 8, training data 804 may include one or more elements that are not categorized; that is, training data 804 may not be formatted or contain descriptors for some elements of data. Machine-learning algorithms and/or other processes may sort training data 804 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 804 to be made applicable for two or more distinct machine-learning algorithms as described in further detail below. Training data 804 used by machine-learning module 800 may correlate any input data as described in this disclosure to any output data as described in this disclosure. As a non-limiting illustrative example flight elements and/or pilot signals may be inputs, wherein an output may be an autonomous function.

Further referring to FIG. 8, training data may be filtered, sorted, and/or selected using one or more supervised and/or unsupervised machine-learning processes and/or models as described in further detail below; such models may include without limitation a training data classifier 816. Training data classifier 816 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 800 may generate a classifier using a classification algorithm, defined as a processes whereby a computing device and/or any module and/or component operating thereon derives a classifier from training data 804. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 416 may classify elements of training data to sub-categories of flight elements such as torques, forces, thrusts, directions, and the like thereof.

Still referring to FIG. 8, machine-learning module 800 may be configured to perform a lazy-learning process 820 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 804. Heuristic may include selecting some number of highest-ranking associations and/or training data 804 elements. Lazy learning may implement any suitable lazy learning algorithm, including without limitation a K-nearest neighbors algorithm, a lazy naive Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 8, machine-learning processes as described in this disclosure may be used to generate machine-learning models 824. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 824 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 824 may be generated by creating an artificial neural network, such as a convolutional neural network comprising an input layer of nodes, one or more intermediate layers, and an output layer of nodes. Connections between nodes may be created via the process of “training” the network, in which elements from a training data 804 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 8, machine-learning algorithms may include at least a supervised machine-learning process 828. At least a supervised machine-learning process 828, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include flight elements and/or pilot signals as described above as inputs, autonomous functions as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 804. Persons skilled in the art, upon reviewing the entirety of this disclosure, will be aware of various possible variations of at least a supervised machine-learning process 828 that may be used to determine relation between inputs and outputs. Supervised machine-learning processes may include classification algorithms as defined above.

Further referring to FIG. 8, machine learning processes may include at least an unsupervised machine-learning processes 832. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 8, machine-learning module 800 may be designed and configured to create a machine-learning model 824 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 8, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include Gaussian processes such as Gaussian Process Regression. Machine-learning algorithms may include cross-decomposition algorithms, including partial least squares and/or canonical correlation analysis. Machine-learning algorithms may include naive Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

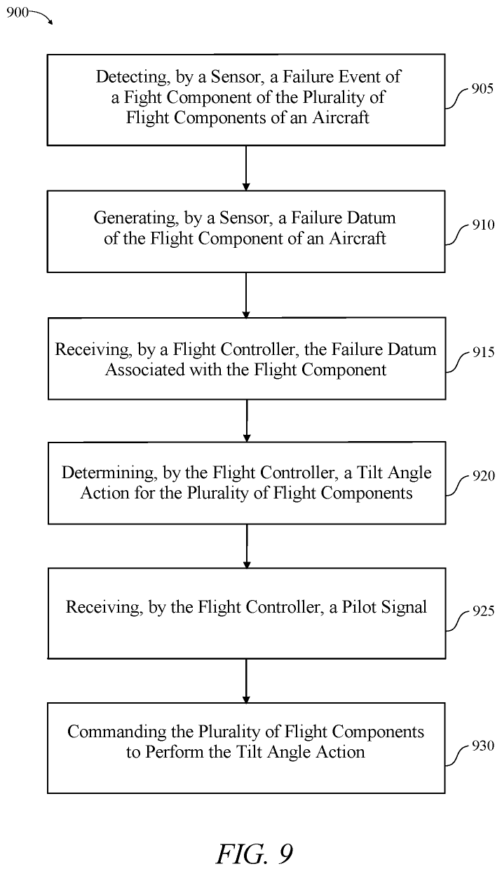

Now referring to FIG. 9, an exemplary embodiment for a method 900 for neutralizing flight is illustrated. At step 905, a sensor detects a failure event of a downward directed propulsor 112 of a plurality of downward directed propulsors. Sensor includes any of the sensor as described above, in reference to FIGS. 1-8. Failure event includes any of the failure event as described above, in reference to FIGS. 1-8. Plurality of downward directed propulsors 112 includes any of the plurality of downward directed propulsors 112 as described above, in reference to FIGS. 1-8.

Still referring to FIG. 9, at step 910, sensor generates a failure datum associated to the plurality of downward directed propulsors 112. Failure datum includes any of the failure datum as described above, in reference to FIGS. 1-8.

Still referring to FIG. 9, at step 915, a flight controller receives failure datum associated with the plurality of downward directed propulsors from sensor. Flight controller includes any of the flight controller as described above, in reference to FIGS. 1-8.

Still referring to FIG. 9, at step 920, flight controller determines a corrective action from a plurality of flight components and/or downward directed propulsor 112 as a function of failure datum. Corrective action includes any of the corrective action as described above, in reference to FIGS. 1-8. Plurality of flight components includes any of the plurality of flight components as described above, in reference to FIGS. 1-8.

Still referring to FIG. 9, at step 925, flight controller 408 receives a pilot signal 732 as a function of a notification unit. Pilot signal 732 includes any of the pilot signal 732 as described above, in reference to FIGS. 1-8. Notification unit includes any of the notification unit as described above, in reference to FIGS. 1-8.

Still referring to FIG. 9, at step 930, flight controller commands an actuator to perform corrective action on the plurality of flight components and/or downward directed propulsors 112. Actuator includes any of the actuator as described above, in reference to FIGS. 1-8.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

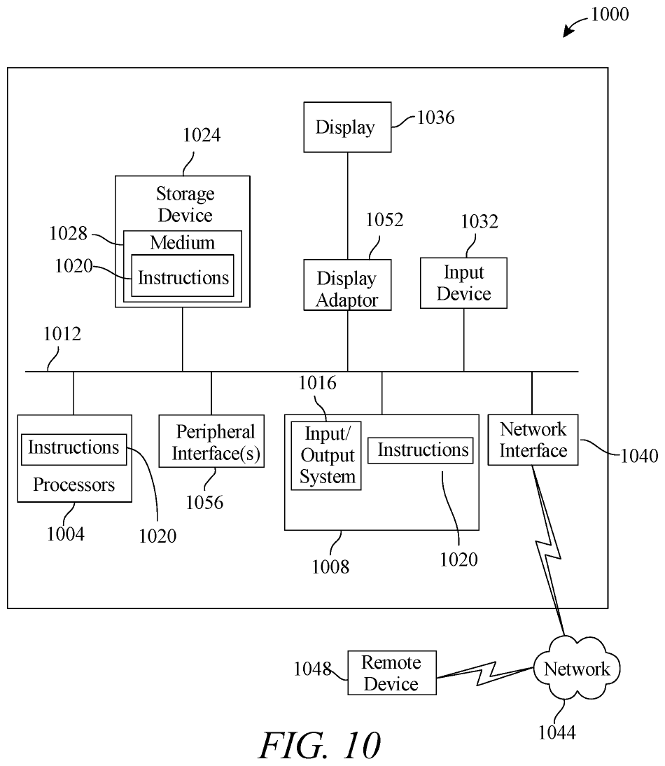

FIG. 10 shows a diagrammatic representation of one embodiment of a computing device in the exemplary form of a computer system 1000 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1000 includes a processor 1004 and a memory 1008 that communicate with each other, and with other components, via a bus 1012. Bus 1012 may include any of several types of bus structures including, but not limited to, a memory bus, a memory controller, a peripheral bus, a local bus, and any combinations thereof, using any of a variety of bus architectures.

Processor 1004 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1004 may be organized according to Von Neumann and/or Harvard architecture as a non-limiting example. Processor 1004 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC).

Memory 1008 may include various components (e.g., machine-readable media) including, but not limited to, a random-access memory component, a read only component, and any combinations thereof. In one example, a basic input/output system 1016 (BIOS), including basic routines that help to transfer information between elements within computer system 1000, such as during start-up, may be stored in memory 1008. Memory 1008 may also include (e.g., stored on one or more machine-readable media) instructions (e.g., software) 1020 embodying any one or more of the aspects and/or methodologies of the present disclosure. In another example, memory 1008 may further include any number of program modules including, but not limited to, an operating system, one or more application programs, other program modules, program data, and any combinations thereof.

Computer system 1000 may also include a storage device 1024. Examples of a storage device (e.g., storage device 1024) include, but are not limited to, a hard disk drive, a magnetic disk drive, an optical disc drive in combination with an optical medium, a solid-state memory device, and any combinations thereof. Storage device 1024 may be connected to bus 1012 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1024 (or one or more components thereof) may be removably interfaced with computer system 1000 (e.g., via an external port connector (not shown)). Particularly, storage device 1024 and an associated machine-readable medium 1028 may provide nonvolatile and/or volatile storage of machine-readable instructions, data structures, program modules, and/or other data for computer system 1000. In one example, software 1020 may reside, completely or partially, within machine-readable medium 1028. In another example, software 1020 may reside, completely or partially, within processor 1004.

Computer system 1000 may also include an input device 1032. In one example, a user of computer system 1000 may enter commands and/or other information into computer system 1000 via input device 1032. Examples of an input device 1032 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1032 may be interfaced to bus 1012 via any of a variety of interfaces (not shown) including, but not limited to, a serial interface, a parallel interface, a game port, a USB interface, a FIREWIRE interface, a direct interface to bus 1012, and any combinations thereof. Input device 1032 may include a touch screen interface that may be a part of or separate from display 1036, discussed further below. Input device 1032 may be utilized as a user selection device for selecting one or more graphical representations in a graphical interface as described above.

A user may also input commands and/or other information to computer system 1000 via storage device 1024 (e.g., a removable disk drive, a flash drive, etc.) and/or network interface device 1040. A network interface device, such as network interface device 1040, may be utilized for connecting computer system 1000 to one or more of a variety of networks, such as network 1044, and one or more remote devices 1048 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 644, may employ a wired and/or a wireless mode of communication. In general, any network topology may be used. Information (e.g., data, software 1020, etc.) may be communicated to and/or from computer system 600 via network interface device 1040.

Computer system 1000 may further include a video display adapter 1052 for communicating a displayable image to a display device, such as display device 1036. Examples of a display device include, but are not limited to, a liquid crystal display (LCD), a cathode ray tube (CRT), a plasma display, a light emitting diode (LED) display, and any combinations thereof. Display adapter 1052 and display device 1036 may be utilized in combination with processor 1004 to provide graphical representations of aspects of the present disclosure. In addition to a display device, computer system 1000 may include one or more other peripheral output devices including, but not limited to, an audio speaker, a printer, and any combinations thereof. Such peripheral output devices may be connected to bus 1012 via a peripheral interface 1056. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve systems and methods according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An aircraft for neutralizing flight, the aircraft comprising:
a fuselage;
at least a power source located within the fuselage;
a plurality of laterally extending elements attached to the fuselage;
a plurality of downward directed propulsors attached to the plurality of laterally extending elements and electrically connected to the at least a power source, wherein the plurality of downward directed propulsors have a rotational axis offset from a vertical axis by a yaw-torque-cancellation angle; and
a flight controller configured to include a notification unit.

2. The aircraft of claim 1, wherein the plurality of downward directed propulsors further comprises:
a first downward directed propulsor having a first yaw-torque-cancellation angle with respect to the vertical axis; and
a second downward directed propulsor having a second yaw-torque-cancellation angle with respect to the vertical axis.

3. The aircraft of claim 1, wherein the yaw-torque-cancellation angle includes a nominal angle and a canted angle.

4. The aircraft of claim 1, wherein each downward directed propulsor of the plurality of downward directed propulsors is attached to the aircraft at a fixed angle.

5. The aircraft of claim 4, wherein each fixed angle includes the respective yaw-torque-cancellation angle.

6. The aircraft of claim 1, further comprising at least an actuator configured to move each propulsor of the plurality of propulsors between the yaw-cancelation angle and a vertically aligned angle.

7. The aircraft of claim 6, wherein the flight controller is configured to command the actuator to move the downward directed propulsor of the plurality of downward directed propulsors between the vertically aligned angle and the yaw-torque-cancellation angle.

8. The aircraft of claim 1, wherein the flight controller is communicatively connected to a sensor.

9. The aircraft of claim 8, wherein the sensor is attached to the aircraft.

10. The aircraft of claim 8, wherein the sensor is configured to: detect a failure event of the downward directed propulsor of the plurality of downward directed propulsors; and
generate a failure datum associated to the downward directed propulsor of the plurality of downward directed propulsors.

11. The aircraft of claim 10, wherein the failure event includes a rotation degradation, wherein the rotation degradation results in a loss of control in the yaw axis.

12. The aircraft of claim 10, wherein generating the failure datum further comprises determining a failure event description.

13. The aircraft of claim 10, wherein the flight controller is configured to:
receive, from the sensor, the failure datum associated with the downward directed propulsor;
determine a corrective action for a flight component of the plurality of flight components as a function of the failure datum; and
command the plurality of flight components to perform the corrective action.

14. The aircraft of claim 13, wherein determining the corrective action further comprises:
receiving a vertically aligned angle of the sensor;
identifying a yaw-torque-cancellation angle as a function of the vertically aligned angle; and
determining the corrective action as a function of the yaw-torque-cancellation angle.

15. The aircraft of claim 14, wherein receiving the vertically aligned angle of the sensor further comprises obtaining a yaw input as a function of a yaw detector and receiving the vertically aligned angle as a function of the yaw input.

16. The aircraft of claim 14, wherein identifying the yaw-torque-cancellation angle further comprises:
receiving a yaw torque as a function of the failure datum;
determining a nullification element as a function of the yaw torque; and
identifying the yaw-torque-cancellation angle as a function of the nullification element.

17. The aircraft of claim 13, wherein the flight controller is further configured to command the actuator to maneuver the flight component of the plurality of flight components as a function of the corrective action.

18. The aircraft of claim 13, wherein performing the corrective action includes vectoring a longitudinal thrust flight component of the plurality of longitudinal thrust flight components.

19. The aircraft of claim 1, wherein the flight controller is further communicatively coupled to the plurality of flight components.

20. The aircraft of claim 1, further comprising an electric aircraft.
